(19) United States
(12) Patent Application Publication
(10) Pub. No.: US 2026/0275149 A1
(43) Pub. Date: Sep. 17, 2026

(54) FORMULATIONS USABLE IN ADDITIVE MANUFACTURING OF 3D OBJECTS THAT FEATURE AN ELASTOMERIC MATERIAL

(71) Applicant: Stratasys Ltd., Rehovot (IL)

(72) Inventors: Yaniv HIRSCHSOHN, Rehovot (IL); Heloise Hannah SIMON DE PAZ, Jerusalem (IL); Lev KUNO, Tzur-Hadassah (IL); Uri ZADOK, Herzliya (IL)

(73) Assignee: Stratasys Ltd., Rehovot (IL)

(21) Appl. No.: 19/470,957

(22) PCT Filed: Mar. 31, 2024
(86) PCT No.: PCT/IL2024/050332

§ 371 Date: Sep. 30, 2025

Related U.S. Application Data
(60) Provisional application No. 63/456,011, filed on Mar. 31, 2023.

(51) Int. Cl. C09D 133/10; B29C 64/129; B29K 33/00; B29K 83/00; B33Y 10/00; B33Y 70/00

(52) U.S. Cl. CPC C09D 133/10; B29C 64/129; B33Y 10/00; B33Y 70/00; B29K 2033/12; B29K 2083/00; B29K 2995/0046; B29K 2995/007; B29K 2995/0077; B29K 2995/0081; B29K 2995/0093

(57) ABSTRACT

A curable formulation that provides, when hardened, an elastomeric material that features improved stability and durability, made of at least one curable, mono-functional, hydrophobic material featuring Tg lower than 0° C.; at least one curable, mono-functional, hydrophobic material featuring Tg of from 0 to 100, or from 20 to 100, or from 20 to 80, ° C.; at least one curable, multi-functional, hydrophobic elastomeric material, and optionally additional curable and non-curable materials, is provided. An additive manufacturing of a three-dimensional object having in at least a portion thereof an elastomeric material, employing a curable formulation as described herein is also provided.

### RELATED APPLICATION/S

This application claims the benefit of priority under 35 USC § 119(e) of U.S. Provisional Patent Application No. 63/456,011 filed on Mar. 31, 2023, the contents of which are incorporated herein by reference in their entirety.

This application is also related to U.S. Provisional Patent Application No. 63/456,005 filed on Mar. 31, 2023, and to co-filed PCT International Patent Application entitled “ELASTOMERIC FORMULATIONS CONTAINING POLYMERIC SILICONE MATERIALS USABLE IN ADDITIVE MANUFACTURING OF 3D OBJECTS”, having attorney's Docket No. 99135, by the present assignee, which claims the benefit of priority of U.S. Provisional Patent Application No. 63/456,005 filed on Mar. 31, 2023, the contents of which are incorporated by reference as if fully set forth herein in their entirety.

### FIELD AND BACKGROUND OF THE INVENTION

The present invention, in some embodiments thereof, relates to three-dimensional printing and, more particularly, but not exclusively, to formulations usable in additive manufacturing of a three-dimensional object, which provide an elastomeric (rubber-like) material, and to methods/processes utilizing same.

Additive manufacturing (AM) is a technology enabling fabrication of shaped structures directly from computer data via additive formation steps. The basic operation of any AM system consists of slicing a three-dimensional computer model into thin cross sections, translating the result into two-dimensional position data and feeding the data to control equipment which fabricates a three-dimensional structure in a layer-wise manner.

Additive manufacturing entails many different approaches to the method of fabrication, including three-dimensional (3D) printing such as 3D inkjet printing, electron beam melting, stereolithography, selective laser sintering, laminated object manufacturing, fused deposition modeling and others.

Some 3D printing processes, for example, 3D inkjet printing, are being performed by a layer-by-layer inkjet deposition of building materials. Thus, a building material is dispensed from a dispensing head having a set of nozzles to deposit layers on a receiving medium. Depending on the building material, the layers may then be cured or solidified using a suitable device, optionally after being leveled by a leveling device.

Various three-dimensional printing techniques exist and are disclosed in, e.g., U.S. Pat. Nos. 6,259,979, 6,569,373, 6,658,314, 6,850,334, 6,863,859, 7,183,335, 7,209,797, 7,225,045, 7,300,619, 7,500,846, 9,031,680 and 9,227,365, U.S. patent application having Publication No. 2006/0054039, WO 2016/009426, and WO 2022/024114 all by the present Assignee, and being hereby incorporated by reference in their entirety.

A printing system utilized in additive manufacturing may include a receiving medium and one or more printing heads. The receiving medium can be, for example, a fabrication tray that may include a horizontal surface to carry the material dispensed from the printing head. The printing head may be, for example, an ink jet head having a plurality of dispensing nozzles arranged in an array of one or more rows along the longitudinal axis of the printing head. The printing head may be located such that its longitudinal axis is substantially parallel to the indexing direction. The printing system may further include a controller, such as a microprocessor to control the printing process, including the movement of the printing head according to a pre-defined scanning plan (e.g., a CAD configuration converted to a Stereo Lithography (STL) format and programmed into the controller). The printing head may include a plurality of jetting nozzles. The jetting nozzles dispense material onto the receiving medium to create the layers representing cross sections of a 3D object.

In addition to the printing head, there may be a source of curing energy, for curing the dispensed building material. The curing energy is typically radiation, for example, UV radiation.

Additionally, the printing system may include a leveling device for leveling and/or establishing the height of each layer after deposition and at least partial solidification, prior to the deposition of a subsequent layer.

The building materials may include modeling materials and support materials, which form the object and the temporary support constructions supporting the object as it is being built, respectively.

The modeling material (which may include one or more material(s)) is deposited to produce the desired object/s and the support material (which may include one or more material(s)) is used, with or without modeling material elements, to provide support structures for specific areas of the object during building and assure adequate vertical placement of subsequent object layers, e.g., in cases where objects include overhanging features or shapes such as curved geometries, negative angles, voids, and so on.

Both the modeling and support materials are preferably liquid at the working temperature at which they are dispensed, and subsequently hardened, typically upon exposure to curing energy (e.g., UV curing), to form the required layer shape. After printing completion, support structures are removed to reveal the final shape of the fabricated 3D object.

In order to be compatible with most of the commercially-available print heads utilized in a 3D inkjet printing system, the uncured building materials should feature the following characteristics: a relatively low viscosity (e.g., Brookfield Viscosity of up to 400 cps, or up to 100 cps, or up to 50 cps, preferably from 8 to 25 cps) at the working (e.g., jetting) temperature; Surface tension of from about 20 to about 100 Dyne/cm, preferably from about 25 to about 40 Dyne/cm; and a Newtonian liquid behavior and high reactivity to a selected curing condition, to enable fast solidification of the jetted layer upon exposure to a curing condition, of no more than 1 minute, preferably no more than 20 seconds.

In a 3D inkjet printing process such as PolyJet™ (Stratasys® Ltd., Israel), the building material is selectively jetted from one or more printing heads and deposited onto a fabrication tray in consecutive layers according to a pre-determined configuration as defined by a software file.

Synthetic rubbers are typically made of artificial elastomers. An elastomer is a viscoelastic polymer, which generally exhibits low Young's modulus and high yield strain compared with other materials. Elastomers are typically amorphous polymers existing above their glass transition temperature, so that considerable segmental motion is possible. At ambient temperatures, rubbers are thus relatively soft, featuring elasticity of about 3 MPa, and deformable.

Elastomers are usually thermosetting polymers (or co-polymers), which require curing (vulcanization) for cross-linking the polymer chains. Commonly used polymers are polybutadienes. The elasticity is derived from the ability of the long chains to reconfigure themselves to distribute an applied stress. The covalent cross-linking ensures that the elastomer will return to its original configuration when the stress is removed. Elastomers can typically reversibly extend from 5% to 700%.

Rubbers often further include fillers or reinforcing agents, usually aimed at increasing their hardness. Most common reinforcing agents include finely divided carbon black and/or finely divided silica.

Both carbon black and silica, when added to the polymeric mixture during rubber production, typically at a concentration of about 30 percent by volume, raise the elastic modulus of the rubber by a factor of two to three, and also confer remarkable toughness, especially resistance to abrasion, to otherwise weak materials. If greater amounts of carbon black or silica particles are added, the modulus is further increased, but the tensile strength may be lowered.

Additive Manufacturing processes have been used to form rubber-like materials. For example, rubber-like materials are used in PolyJet™ systems as described herein. These materials are formulated to have relatively low viscosity permitting dispensing, for example by inkjet, and to develop Tg which is lower than room temperature, e.g., −10° C. or lower. The latter is obtained by formulating a product with relatively low degree of cross-linking and by using monomers and oligomers with intrinsic flexible molecular structure (e.g., acrylic elastomers).

An exemplary family of rubber-like materials usable in PolyJet™ systems (marketed under the trade name “Tango” family) offers a variety of elastomer characteristics of the obtained hardened material, including Shore scale A hardness, elongation at break, Tear Resistance and tensile strength. The softest material in this family features a Shore A hardness of 27.

Another family of Rubber-like materials usable in PolyJet™ systems (marketed under the trade name “Agilus” family) is described in PCT International Application No. IL2017/050604 (published as WO 2017/208238), by the present assignee, and utilizes an elastomeric curable material and silica particles.

WO 2022/264139, also by the present assignee, describes formulations based on curable mono-functional and multi-functional elastomeric materials, in combination with a curable, multi-functional, non-elastomeric material and a curable material that comprises at least two hydrogen bond forming groups, which are usable for providing rubber-like materials that meet the process requirements when used in 3D-inkjet printing systems equipped with a LED source (which emits irradiation at a wavelength of e.g., 365-405 nm) as a curing energy.

WO 2022/024114 describes a system for three-dimensional printing, which comprises an array of nozzles for dispensing building materials, a work tray, a jig for affixing a fabric to the work tray, and a computerized controller for operating the array of nozzles to dispense a building material on the affixed fabric. An imaging system may be positioned to image a fabric placed on the work tray, and image data received from the imaging system may be processed to identify patterns on the fabric, wherein the nozzles dispense the building material at locations selected relative to the identified features.

Rubber-like materials are useful for many modeling applications including: exhibition and communication models; rubber surrounds and over-molding; soft-touch coatings and nonslip surfaces for tooling or prototypes; and knobs, grips, pulls, handles, gaskets, seals, hoses, footwear.

Additional background art includes U.S. Pat. Nos. 9,227,365; 6,242,149; U.S. patent application having Publication No. 2010/0140850; WO 2009/013751; WO 2016/063282; WO 2016/125170; WO 2017/134672; WO 2017/134673; WO 2017/134674; WO 2017/134676; WO 2017/068590; WO 2017/187434; WO 2018/055521; WO 2018/055522; and WO 2020/065654; all by the present assignee.

### SUMMARY OF THE INVENTION

According to an aspect of some embodiments of the present invention there is provided a curable formulation that provides, when hardened, an elastomeric material, the formulation comprising: at least one curable, mono-functional, hydrophobic material featuring Tg lower than 0° C. (Component A); at least one curable, mono-functional, hydrophobic material featuring Tg of from 0 to 100, or from 20 to 100, or from 20 to 80, ° C. (Component B); and at least one curable, multi-functional, hydrophobic elastomeric material (Component E). The curable formulation is also referred to herein as an elastomeric curable formulation or as an elastomeric formulation or as a hydrophobic elastomeric formulation.

According to some of any of the embodiments described herein, the hardened elastomeric material features at least one of: elongation at break of at least 200%; Tensile strength of at least 2 MPa; Resilience (EDE) of at least 20%; Tear resistance of at least 5 Kg/cm; and Shore A hardness of at least 30, or at least 35.

According to some of any of the embodiments described herein, each of the curable materials is a UV-curable material.

According to some of any of the embodiments described herein, the curable formulation further comprises a photoinitiator (Component I).

According to some of any of the embodiments described herein, an amount of the photoinitiator (Component I) ranges from 1 to 3, or from 1 to 2, % by weight of the total weight of the formulation.

According to some of any of the embodiments described herein, each of the curable materials is a (meth)acrylic material.

According to some of any of the embodiments described herein, the at least one curable, multi-functional, hydrophobic elastomeric material (Component E) comprises a polybutadiene moiety.

According to some of any of the embodiments described herein, the at least one curable, multi-functional, hydrophobic elastomeric material (Component E) comprises a multi-functional urethane (meth)acrylate.

According to some of any of the embodiments described herein, an amount of the at least one curable, multi-functional, hydrophobic elastomeric material (Component E) is at least 20, or at least 25%, by weight, of the total weight of the formulation.

According to some of any of the embodiments described herein, an amount of the at least one curable, multi-functional, hydrophobic elastomeric material (Component E) ranges from 20 to 30, or from 25 to 30, % by weight, of the total weight of the formulation.

According to some of any of the embodiments described herein, the at least one curable, mono-functional, hydrophobic material featuring Tg of from 0 to 100° C. (Component B) comprises at least one curable material that comprises an alicyclic moiety.

According to some of any of the embodiments described herein, the at least one curable, mono-functional, hydrophobic material featuring Tg of from 0 to 100° C. (Component B) comprises at least one curable, mono-functional, hydrophobic material featuring a viscosity higher than 10 centipoises at 25° C. (Component B1), and at least one curable, mono-functional, hydrophobic material featuring a viscosity lower than 10 centipoises at 25° C. (Component B2).

According to some of any of the embodiments described herein, each of the Component B1 and Component B2 comprises an alicyclic moiety (e.g., of at least 6 carbon atoms).

According to some of any of the embodiments described herein, a weight ratio of the at least one curable, mono-functional, hydrophobic material featuring a viscosity higher than 10 centipoises at 25° C. (Component B1), and the at least one curable, mono-functional, hydrophobic material featuring a viscosity lower than 10 centipoises at 25° C. (Component B2), ranges from 2:1 to 1:2.

According to some of any of the embodiments described herein, an amount of the at least one curable, mono-functional, hydrophobic material featuring a viscosity higher than 10 centipoises at 25° C. (Component B1) ranges from 20 to 30, or from 35 to 30, % by weight of the total weight of the formulation.

According to some of any of the embodiments described herein, an amount of and the at least one curable, mono-functional, hydrophobic material featuring a viscosity lower than 10 centipoises at 25° C. (Component B2), ranges from 25 to 35, % by weight of the total weight of the formulation.

According to some of any of the embodiments described herein, a total amount of the at least one curable, mono-functional, hydrophobic material featuring Tg of from 0 to 100° C. (Component B) is at least 45, or at least 50, % by weight of the total weight of the formulation.

According to some of any of the embodiments described herein, a total amount of the at least one curable, mono-functional, hydrophobic material featuring Tg of from 0 to 100° C. (Component B) ranges from 45 to 60, or from 45 to 55, or from 50 to 60, or from 50 to 55, % by weight of the total weight of the formulation.

According to some of any of the embodiments described herein, a weight ratio of a total amount of the at least one curable, multi-functional, hydrophobic elastomeric material (Component E) and a total amount of the at least one curable, multi-functional hydrophobic material featuring Tg of from 0 to 100° C. (Component B) ranges from 1:1 to 1:2.

According to some of any of the embodiments described herein, the at least one curable, mono-functional, hydrophobic material featuring Tg lower than 0° C. (Component A) comprises a linear aliphatic moiety (of at least 6 carbon atoms in length).

According to some of any of the embodiments described herein, a total amount of the at least one curable, mono-functional, hydrophobic material featuring Tg lower than 0° C. (Component A) is at least 10% by weight of the total weight of the formulation.

According to some of any of the embodiments described herein, a total amount of the at least one curable, mono-functional, hydrophobic material featuring Tg lower than 0° C. (Component A) ranges from 10 to 20, % by weight of the total weight of the formulation.

According to some of any of the embodiments described herein, a weight ratio of a total amount of the at least one curable, multi-functional, hydrophobic elastomeric material (Component E) and a total amount of the at least one curable, mono-functional, hydrophobic material featuring Tg lower than 0° C. (Component A) ranges from 1:1 to 2:1.

According to some of any of the embodiments described herein, a weight ratio of a total amount of the at least one curable, mono-functional, hydrophobic material featuring Tg of from 0 to 100° C. (Component B) and a total amount of the at least one curable, mono-functional, hydrophobic material featuring Tg lower than 0° C. (Component A) ranges from 2:1 to 3:1.

According to some of any of the embodiments described herein, the curable formulation further comprises at least one curable, multi-functional (e.g., tri-functional), material featuring Tg of from 50 to 150° C. (Component D).

According to some of any of the embodiments described herein, the at least one curable, multi-functional, material featuring Tg of from 50 to 150° C. (Component D) is an amphiphilic (e.g., ethoxylated) curable, multi-functional material.

According to some of any of the embodiments described herein, an amount of the at least one curable, multi-functional, material featuring Tg of from 50 to 150 0° C. (Component D) ranges from 1 to 10, or from 1 to 5, % by weight, of the total weight of the formulation.

According to some of any of the embodiments described herein, the curable formulation further comprises at least one silicone-containing polymeric material (Component F).

According to some of any of the embodiments described herein, a total amount of the at least one silicone-containing polymeric material (Component F) ranges from 1 to 20, or from 5 to 20, or from 1 to 10, or from 5 to 10, % by weight of total weight of the formulation.

According to some of any of the embodiments described herein, the at least one silicone-containing polymeric material (Component F) comprises at least one curable silicone-containing polymeric material (Component F1), which can be mono-functional and/or multi-functional (e.g., di-functional) and/or at least one non-curable silicone-containing polymeric material (Component F2).

According to some of any of the embodiments described herein, the curable formulation further comprises at least one material selected from a surfactant, a dispersant, a filler, a dye, a pigment, an inhibitor and an anti-oxidant.

According to some of any of the embodiments described herein, the curable formulation is usable as a modeling material formulation in additive manufacturing of a three-dimensional object that comprises, in at least a portion thereof, an elastomeric material.

According to an aspect of some embodiments of the present invention there is provided a method of additive manufacturing a three-dimensional object comprising, in at least a portion thereof, an elastomeric material, the method comprising sequentially forming a plurality of layers in a configured pattern corresponding to the shape of the object, thereby forming the object, wherein the formation of each of at least a few of the layers comprises dispensing a modeling material formulation that comprises the curable formulation as described herein in any of the respective embodiments and any combination thereof, and exposing the dispensed modeling material to a curing energy to thereby form a cured modeling material, thereby manufacturing the three-dimensional object.

According to some of any of the embodiments described herein, the curing energy comprises UV irradiation.

According to some of any of the embodiments described herein, the UV irradiation is from a LED energy source.

According to an aspect of some embodiments of the present invention there is provided a three-dimensional object manufactured by the method as described herein in any of the respective embodiments.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

Implementation of the method and/or system of embodiments of the invention can involve performing or completing selected tasks manually, automatically, or a combination thereof. Moreover, according to actual instrumentation and equipment of embodiments of the method and/or system of the invention, several selected tasks could be implemented by hardware, by software or by firmware or by a combination thereof using an operating system.

For example, hardware for performing selected tasks according to embodiments of the invention could be implemented as a chip or a circuit. As software, selected tasks according to embodiments of the invention could be implemented as a plurality of software instructions being executed by a computer using any suitable operating system. In an exemplary embodiment of the invention, one or more tasks according to exemplary embodiments of method and/or system as described herein are performed by a data processor, such as a computing platform for executing a plurality of instructions. Optionally, the data processor includes a volatile memory for storing instructions and/or data and/or a non-volatile storage, for example, a magnetic hard-disk and/or removable media, for storing instructions and/or data. Optionally, a network connection is provided as well. A display and/or a user input device such as a keyboard or mouse are optionally provided as well.

### BRIEF DESCRIPTION OF THE SEVERAL VIEWS OF THE DRAWING(S)

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIGS. 1A-1D are schematic illustrations of an additive manufacturing system according to some embodiments of the invention.

FIGS. 2A-2C are schematic illustrations of printing heads according to some embodiments of the present invention.

FIGS. 3A and 3B are schematic illustrations demonstrating coordinate transformations according to some embodiments of the present invention.

### DESCRIPTION OF SPECIFIC EMBODIMENTS OF THE INVENTION

The present invention, in some embodiments thereof, relates to three-dimensional printing and, more particularly, but not exclusively, to formulations usable in additive manufacturing of a three-dimensional object, which provide an elastomeric (rubber-like) material, and to methods/processes utilizing same.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

In conventional production of elastomeric materials (elastomers, rubber-like materials), the starting material is typically a thermoplastic polymer with low Tg, which is compounded and cured or vulcanized to achieve the desired final properties. In contrast, in additive manufacturing processes such as 3D (inkjet) printing, a cured polymer is produced in one stage from suitable monomers and/or low molecular weight (e.g., lower than 1,000 grams/mol or lower than 500 grams/mol) cross-linkers and oligomers. Controlling the molecular weight, cross-linking density and mechanical properties of the obtained rubber-like materials in such processes is therefore challenging. Thus, for example, PolyJet™ rubber-like materials are often characterized by low Tear Resistance (TR) value and/or slow return velocity after deformation, when compared, for example, to conventional elastomers. PolyJet™ rubber-like materials which exhibit high elongation are often characterized by low modulus, low Tear Resistance and/or low Tg and tackiness.

The present inventors have now designed and successfully practiced novel formulations that are suitable for use in additive manufacturing (e.g., feature properties that meet the AM process requirements as described herein) and that provide, when hardened, hydrophobic rubber-like materials. The novel formulations include a combination of hydrophobic curable materials, optionally along with amphiphilic curable materials and non-curable materials. As demonstrated in the Examples section that follows, the present inventors have showed that using such formulations, rubber-like materials featuring improved mechanical properties that are not deteriorated when maintained in ambient (e.g., humid) environment may be formed.

Herein throughout, the phrases “rubber”, “rubbery materials”, “elastomeric materials” and “elastomers” are used interchangeably to describe materials featuring characteristics of elastomers. The phrase “rubbery-like material” or “rubber-like material” is used to describe materials featuring characteristics of rubbers, prepared by additive manufacturing (e.g., 3D inkjet printing) rather than conventional processes that involve vulcanization of thermoplastic polymers. These terms are used to describe the material obtained upon hardening or solidification of a formulation as described herein.

The term “rubbery-like material” is also referred to herein interchangeably as “elastomeric material”.

Elastomers, or rubbers, are flexible materials that are typically characterized by low Tg (e.g., lower than room temperature, preferably lower than 10° C., lower than 0° C. and even lower than −10° C.).

The following describes some of the properties characterizing rubbery materials, as used herein and in the art.

Shore A Hardness, which is also referred to as Shore hardness or simply as hardness, describes a material's resistance to permanent indentation, defined by type A durometer scale.

Shore hardness is typically determined according to ASTM D2240. Elastic Modulus, which is also referred to as Modulus of Elasticity or as Young's Modulus, or as Tensile modulus, or “E”, describes a material's resistance to elastic deformation when a force is applied, or, in other words, as the tendency of an object to deform along an axis when opposing forces are applied along that axis. Elastic modulus is typically measured by a tensile test (e.g., according to ASTM D 624) and is determined by the linear slope of a Stress-Strain curve in the elastic deformation region, wherein Stress is the force causing the deformation divided by the area to which the force is applied and Strain is the ratio of the change in some length parameter caused by the deformation to the original value of the length parameter. The stress is proportional to the tensile force on the material and the strain is proportional to its length.

Tensile Strength describes a material's resistance to tension, or, in other words, its capacity to withstand loads tending to elongate, and is defined as the maximum stress in MPa, applied during stretching of an elastomeric composite before its rupture. Tensile strength is typically measured by a tensile test (e.g., according to ASTM D 624) and is determined as the highest point of a Stress-Strain curve, as described herein and in the art.

Elongation, or elongation at break, is the extension of a uniform section of a material, expressed as percent of the original length as follows:

$$Elongation \% = \frac{Final length - Original length}{Original length} \times 100.$$

Elongation or elongation at break is typically determined according to ASTM D412.

Z Tensile elongation is the elongation measured as described herein upon printing in Z direction.

Tear Resistance (TR), which is also referred to herein and in the art as “Tear Strength” describes the maximum force required to tear a material, expressed in N per mm, or as Kg per cm, whereby the force acts substantially parallel to the major axis of the sample. Tear Resistance can be measured by the ASTM D 412 method. ASTM D 624 can be used to measure the resistance to the formation of a tear (tear initiation) and the resistance to the expansion of a tear (tear propagation). Typically, a sample is held between two holders and a uniform pulling force is applied until deformation occurs. Tear Resistance is then calculated by dividing the force applied by the thickness of the material. Materials with low Tear Resistance tend to have poor resistance to abrasion.

Tear Resistance under constant elongation describes the time required for a specimen to tear when subjected to constant elongation (lower than elongation at break). This value is determined, for example, in an “O-ring” test as described, for example, in WO 2017/208238.

Resilience, which is also referred to herein as energy dissipation efficiency (EDE), describes an ability of a material to return to its original shape after temporary deflection. Resilience can be determined as described in the Examples section that follows. In exemplary embodiments, resilience is determined based on cyclic strain-strain curves, according to the respective equation presented in the Examples section that follows.

Embodiments of the present invention relate to formulations usable in additive manufacturing of three-dimensional (3D) objects or parts (portions) thereof made of rubbery-like materials, to additive manufacturing processes utilizing same, and to objects fabricated by these processes.

Herein throughout, the term “object” describes a final product of the additive manufacturing. This term refers to the product obtained by a method as described herein, after removal of the support material, if such has been used as part of the building material. The “object” therefore essentially consists (at least 95 weight percents) of a hardened (e.g., cured) modeling material.

The term “object” as used herein throughout refers to a whole object or a part thereof.

An object according to the present embodiments is such that at least a part or a portion thereof is made of a rubbery-like material, and is also referred to herein as “an object made of a rubbery-like material”. The object may be such that several parts or portions thereof are made of a rubbery-like material, or such that is entirely made of a rubbery-like material. The rubbery-like material can be the same or different in the different parts or portions, and, for each part, portion or the entire object made of a rubbery-like material, the rubbery-like material can be the same or different within the portion, part or object. When different rubbery-like materials are used, they can differ in their chemical composition and/or mechanical properties, as is further explained hereinafter.

Herein throughout, the phrases “building material formulation”, “uncured building material”, “uncured building material formulation”, “building material” and other variations therefore, collectively describe the materials that are dispensed to sequentially form the layers, as described herein. This phrase encompasses uncured materials dispensed so as to form the object, namely, one or more uncured modeling material formulation(s), and uncured materials dispensed so as to form the support, namely uncured support material formulations.

Herein throughout, the phrase “cured modeling material” or “hardened modeling material” describes the part of the building material that forms the object, as defined herein, upon exposing the dispensed building material to curing, and, optionally, if a support material has been dispensed, also upon removal of the cured support material, as described herein. The cured modeling material can be a single cured material or a mixture of two or more cured materials, depending on the modeling material formulations used in the method, as described herein.

The phrase “cured modeling material” or “cured modeling material formulation” can be regarded as a cured building material wherein the building material consists only of a modeling material formulation (and not of a support material formulation). That is, this phrase refers to the portion of the building material, which is used to provide the final object.

Herein throughout, the phrase “modeling material formulation”, which is also referred to herein interchangeably as “modeling formulation”, “model formulation” “model material formulation” or simply as “formulation”, describes a part or all of the building material which is dispensed so as to form the object, as described herein. The modeling material formulation is an uncured modeling formulation (unless specifically indicated otherwise), which, upon exposure to curing energy, forms the object or a part thereof.

In some embodiments of the present invention, a modeling material formulation is formulated for use in three-dimensional inkjet printing and is able to form a three-dimensional object on its own, i.e., without having to be mixed or combined with any other substance.

An uncured building material can comprise one or more modeling formulations, and can be dispensed such that different parts of the object are made, upon curing, of different cured modeling formulations or different combinations thereof, and hence are made of different cured modeling materials or different mixtures of cured modeling materials.

The formulations forming the building material (modeling material formulations and support material formulations) comprise one or more curable materials, which, when exposed to curing energy, form hardened (cured) material.

The formulations forming the building material (modeling material formulations and support material formulations) are also referred to herein as curable formulations (e.g., a curable modeling material formulation or a curable support material formulation).

Herein throughout, a “curable material” is a compound (typically a monomeric or oligomeric compound, yet optionally a polymeric material) which, when exposed to a curing condition (e.g., curing energy), as described herein, solidifies or hardens to form a cured material. Curable materials are typically polymerizable materials, which undergo polymerization and/or cross-linking when exposed to a suitable energy source.

A curable material, according to the present embodiments, also encompasses materials which harden or solidify (cure) without being exposed to a curing energy, but rather to another curing condition (for example, upon exposure to a chemical reagent or simply upon exposure to the environment).

The terms “curable” and “solidifiable” as used herein are interchangeable.

The polymerization can be, for example, free-radical polymerization, cationic polymerization or anionic polymerization, and each can be induced when exposed to curing energy such as, for example, radiation, heat, etc., as described herein.

In some of any of the embodiments described herein, a curable material is a photopolymerizable material, which polymerizes and/or undergoes cross-linking upon exposure to radiation, as described herein, and in some embodiments the curable material is a UV-curable material, which polymerizes and/or undergoes cross-linking upon exposure to UV radiation, as described herein.

In some embodiments, a curable material as described herein is a photopolymerizable material that polymerizes via photo-induced free-radical polymerization. Alternatively, the curable material is a photopolymerizable material that polymerizes via photo-induced cationic polymerization.

In some of any of the embodiments described herein, a curable material can be a monomer, an oligomer or a short-chain polymer, each being polymerizable and/or cross-linkable as described herein.

In some of any of the embodiments described herein, when a curable material is exposed to curing energy (e.g., radiation), it hardens (cured) by any one, or combination, of chain elongation and cross-linking.

In some of any of the embodiments described herein, a curable material is a monomer or a mixture of monomers which can form a polymeric material upon a polymerization reaction, when exposed to curing energy at which the polymerization reaction occurs. Such curable materials are also referred to herein as monomeric curable materials.

In some of any of the embodiments described herein, a curable material is an oligomer or a mixture of oligomers which can form a polymeric material upon a polymerization reaction, when exposed to curing energy at which the polymerization reaction occurs. Such curable materials are also referred to herein as oligomeric curable materials.

In some of any of the embodiments described herein, a curable material, whether monomeric or oligomeric, can be a mono-functional curable material or a multi-functional curable material.

Herein, a mono-functional curable material comprises one functional group that can undergo polymerization when exposed to curing energy (e.g., radiation).

A multi-functional curable material comprises two or more, e.g., 2, 3, 4 or more, functional groups that can undergo polymerization when exposed to curing energy. Multi-functional curable materials can be, for example, di-functional, tri-functional or tetra-functional curable materials, which comprise 2, 3 or 4 groups that can undergo polymerization, respectively (also referred to herein as featuring a functionality of 2, 3, or 4, etc.). The two or more functional groups in a multi-functional curable material are typically linked to one another by a linking moiety, as defined herein. When the linking moiety is an oligomeric or polymeric moiety, the multi-functional group is an oligomeric or polymeric multi-functional curable material. Multi-functional curable materials can undergo polymerization when subjected to curing energy and/or act as cross-linkers.

The method of the present embodiments manufactures three-dimensional objects in a layer-wise manner by forming a plurality of layers in a configured pattern corresponding to the shape of the objects, as described herein.

The final three-dimensional object is made of the modeling material or a combination of modeling materials or a combination of modeling material/s and support material/s or modification thereof (e.g., following curing). All these operations are well-known to those skilled in the art of solid freeform fabrication.

According to an aspect of some embodiments of the present invention there is provided a method of additive manufacturing of a three-dimensional object made of an elastomeric (rubbery-like) material, as described herein.

The method is generally effected or performed by sequentially forming a plurality of layers in a configured pattern corresponding to the shape of the object, such that formation of each of at least a few of said layers, or of each of said layers, comprises dispensing a building material (uncured) which comprises one or more modeling material formulation(s), and optionally a support material formulation, and exposing the dispensed modeling and optionally support material formulations to a curing condition (e.g., curing energy) to thereby form a cured modeling material, and optionally a cured support material, as described in further detail hereinafter.

In some exemplary embodiments of the invention an object is manufactured by dispensing a building material (uncured) that comprises two or more different modeling material formulations, each modeling material formulation from a different nozzle array of the inkjet printing apparatus. The modeling material formulations are optionally and preferably deposited in layers during the same pass of the printing heads. The modeling material formulations and/or combination of formulations within the layer are selected according to the desired properties of the object, and as further described in detail hereinbelow.

The phrase “digital materials”, as used herein and in the art, describes a combination of two or more materials on a microscopic scale or voxel level such that the printed zones of a specific material are at the level of few voxels, or at a level of a voxel block. Such digital materials may exhibit new properties that are affected by the selection of types of materials and/or the ratio and relative spatial distribution of two or more materials.

In exemplary digital materials, the modeling material of each voxel or voxel block, obtained upon curing, is independent of the modeling material of a neighboring voxel or voxel block, obtained upon curing, such that each voxel or voxel block may result in a different model material and the new properties of the whole part are a result of a spatial combination, on the voxel level, of several different model materials.

Herein throughout, whenever the expression “at the voxel level” is used in the context of a different material and/or properties, it is meant to include differences between voxel blocks, as well as differences between voxels or groups of few voxels. In preferred embodiments, the properties of the whole part are a result of a spatial combination, on the voxel block level, of several different model materials.

### The Curable Elastomeric Formulation:

According to an aspect of some embodiments of the present invention, there is provided a curable formulation that provides, when hardened, an elastomeric material. According to the present embodiments, the curable formulation is designed so as to provide, when hardened, a hydrophobic elastomeric material.

As used herein throughout, the term “hydrophobic” describes a physical property of a material or a portion of a material (e.g., a chemical group in a compound) which does not form bond(s) with water molecules.

In the context of a hardened material, a hydrophobic material is such that is characterized by low or null water absorption, for example, lower than 1%, or lower than 0.5%, or lower than 0.1%, or lower than 0.05%, or even lower. Water absorption can be determined using methods known in the art. Alternatively, a hydrophobic hardened material can be determined by comparing mechanical properties (e.g., Tensile Strength, Shore A hardness, Elongation at break and/or Tear Resistance) of the material upon storage under dry and wet (e.g., when immersed in water) environments, at room temperature. When a change of no more than 10%, or no more than 5%, is observed in at least one property, the hardened material is considered hydrophobic.

As used herein throughout, and discussed hereinabove, an elastomeric hardened material is typically characterized by one or more of the following:

Tear Resistance of at least 4 or at least 4.5 Kg/cm, for example, from 4 to 8, or from 4 to 7.5, or from 4.5 to 8, or from 4.5 to 7.5, Kg/cm, including any intermediate values and subranges therebetween;

Tensile Strength of at least 2, or at least 2.5, MPa, for example, from 2 to 6, or from 2 to 5, or from 2 to 3, or from 2 to 4, or from 3 to 5, MPa, including any intermediate values and subranges therebetween;

Elongation at break of at least 300, or at least 350, %, for example, from 300 to 500, or from 300 to 450, or from 300 to 400, or from 350 to 500, or from 350 to 450, or from 350 to 400, %, including any intermediate values and subranges therebetween;

Shore A hardness of at least 30, or at least 40, for example, from 30 to 50, or from 30 to 40, or from 35 to 50, or from 40 to 50, or from 35 to 45, including any intermediate values and subranges therebetween;

Tg (e.g., average Tg) of no more than 15, or no more than 10, or no more than 5, or no more than 0° C., or Tg that is lower by at least 10, or at least 15, or at least 20° C., of a temperature of an AM system to be practiced, as described herein; and

Resilience (EDE) of at least 20%, preferably of at least 30, at least 40, at least 50, at least 60, more preferably at least 70%, for example, from 20 to 100, or from 30 to 100, or from 40 to 100, or from 50 to 100, or from 60 to 100, or from 70 to 100, or from 70 to 90, or from 70 to 80, %, when measured as described herein;

According to some of any of the embodiments described herein, the curable elastomeric formulation features one, two, three, four or all of the above characteristics.

According to some of any of the embodiments described herein, the elastomeric curable formulations of the present embodiments are further characterized by good printability and stability, as described in the Examples section that follows, and as providing, when used in additive manufacturing, objects that feature minimal deformation, curling and/or volume shrinkage.

According to some of any of the embodiments described herein, the curable formulation features one or more of the above characteristics when hardened upon exposure to irradiation as the curing condition (electromagnetic curing energy), in some embodiments, upon exposure to irradiation at the UV-vis range, and in some of these embodiments, upon exposure to UV irradiation from a LED source.

According to some of any of the embodiments described herein, the curable formulation features one or more of the above characteristics when hardened upon exposure to irradiation as the curing condition (electromagnetic curing energy), at a temperature of no more than 40° C., or no more than 35° C. In some of these embodiments, the irradiation is UV irradiation from a LED source.

According to some of any of the embodiments described herein, the formulation comprises one or more mono-functional curable materials and one or more multi-functional curable, and of these curable materials, at least 80%, or at least 90%, by weight, of the total weight of the formulation, are hydrophobic curable materials.

In the context of curable materials, the term “hydrophobic” describes a physical property of a material or a portion of a material (e.g., a chemical group in a compound) which does not form bond(s) with water molecules.

Hydrophobic materials dissolve more readily in oil than in water or other hydrophilic solvents. Hydrophobic materials can be determined by, for example, as having Log P higher than 1, when Log P is determined in octanol and water phases, at room temperature.

Hydrophobic materials can alternatively, or in addition, be determined as featuring a lipophilicity/hydrophilicity balance (HLB), according to the Davies method, lower than 3.

As used herein throughout, the term “hydrophilic” describes a physical property of a material or a portion of a material (e.g., a chemical group in a compound) which accounts for transient formation of bond(s) with water molecules, typically through hydrogen bonding.

Hydrophilic materials dissolve more readily in water than in oil or other hydrophobic solvents. Hydrophilic materials can be determined by, for example, as having Log P lower than 0.5, when Log P is determined in octanol and water phases, at room temperature.

Hydrophilic materials can alternatively, or in addition, be determined as featuring a lipophilicity/hydrophilicity balance (HLB), according to the Davies method, of at least 10, or of at least 12.

As used herein throughout, the term “amphiphilic” describes a property of a material that combines both hydrophilicity, as described herein for hydrophilic materials, and hydrophobicity or lipophilicity, as defined herein for hydrophobic materials.

Amphiphilic materials typically comprise both hydrophilic groups as defined herein and hydrophobic groups, as defined herein, and are substantially soluble in both water and a water-immiscible solvent (oil).

Amphiphilic materials can be determined by, for example, as having Log P of 0.8 to 1.2, or of about 1, when Log P is determined in octanol and water phases, at room temperature.

Amphiphilic materials can alternatively, or in addition, be determined as featuring a lipophilicity/hydrophilicity balance (HLB), according to the Davies method, of 3 to 12, or 3 to 9.

A hydrophilic material or portion of a material (e.g., a chemical group in a compound) is one that is typically charge-polarized and capable of forming hydrogen bonding.

Amphiphilic materials typically comprise one or more hydrophilic groups (e.g., a charge-polarized group), in addition to hydrophobic groups.

A hydrophobic material or portion of a material (e.g., a chemical group in a compound) is one that is typically non-polarized and incapable of forming hydrogen bonding.

Hydrophilic materials or groups, and amphiphilic materials, typically include one or more electron-donating heteroatoms which form strong hydrogen bonds with water molecules. Such heteroatoms include, but are not limited to, oxygen and nitrogen. Preferably, a ratio of the number of carbon atoms to a number of heteroatoms in a hydrophilic materials or groups is 10:1 or lower, and can be, for example, 8:1, more preferably 7:1, 6:1, 5:1 or 4:1, or lower. It is to be noted that hydrophilicity and amphiphilicity of materials and groups may result also from a ratio between hydrophobic and hydrophilic moieties in the material or chemical group, and does not depend solely on the above-indicated ratio.

A hydrophilic or amphiphilic material can have one or more hydrophilic groups or moieties. Hydrophilic groups are typically polar groups, comprising one or more electron-donating heteroatoms such as oxygen and nitrogen.

Exemplary hydrophilic groups include, but are not limited to, an electron-donating heteroatom, a carboxylate, a thiocarboxylate, oxo (═O), a linear amide, hydroxy, a (C1-4)alkoxy, an (C1-4)alcohol, a heteroalicyclic (e.g., having a ratio of carbon atoms to heteroatoms as defined herein), a cyclic carboxylate such as lactone, a cyclic amide such as lactam, a carbamate, a thiocarbamate, a cyanurate, an isocyanurate, a thiocyanurate, urea, thiourea, an alkylene glycol (e.g., ethylene glycol or propylene glycol), and a hydrophilic polymeric or oligomeric moiety, as these terms are defined hereinunder, and any combinations thereof (e.g., a hydrophilic group that comprises two or more of the indicated hydrophilic groups).

In some embodiments, the hydrophilic group is, or comprises, an electron donating heteroatom, a carboxylate, a heteroalicyclic, an alkylene glycol and/or a hydrophilic oligomeric moiety.

An amphiphilic moiety or group typically comprises one or more hydrophilic groups as described herein and one or more hydrophobic groups, or, can a heteroatom-containing group or moiety in which the ratio of number of carbon atoms to the number of heteroatoms accounts for amphiphilicity.

Hydrophobic groups include, for example, all-carbon groups such as alkyl, alkenyl, alkynyl, aryl, cycloalkyl, and the like. Preferably, these groups include at least 4 carbon atoms, or at least 6 carbon atoms, and preferably more, for example, at least 8, 9, 10, or more, carbon atoms.

According to some any of the embodiments described herein, the formulation comprises at least one curable, mono-functional, hydrophobic material featuring Tg lower than 0° C. (which is also referred to herein, e.g., as Component A); at least one curable, mono-functional, hydrophobic material featuring Tg of from 0 to 100, or from 20 to 100, or from 20 to 80, ° C. (which is also referred to herein, e.g., as Component B); and at least one curable, multi-functional, hydrophobic elastomeric material (which is also referred to herein, e.g., as Component E). According to some of these embodiments, the formulation provides, when hardened (upon exposure to a curing condition as described herein), a hardened elastomeric material that features one or more of the characterizing features as described hereinabove.

According to some any of the embodiments described herein, each of the curable materials is a UV-curable material, as described herein, and the formulation further comprises a photoinitiator (which is also referred to herein as Component E), as described in further detail hereinunder.

According to some of any of the embodiments described herein, each of the curable materials is a (meth)acrylic material, as described herein, and in some embodiments, each of the hydrophobic materials as described herein, is a (meth)acrylic material.

Mono-functional (meth)acrylic materials can be collectively represented by Formula I:

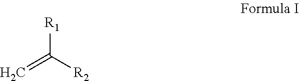

wherein R₁ and/or R₂ is and/or comprises a moiety that renders the material hydrophobic, hydrophilic or amphiphilic, and/or elastomeric.

The (═CH₂) group in Formula I represents a polymerizable group, and is, according to some embodiments, a UV-curable group, such that the curable material is a UV-curable material.

In some embodiments, R₁ is a carboxylate, —C(═O)—O—Ra and the compound is a mono-functional acrylate monomer. In some of these embodiments, R₂ is methyl, and the compound is mono-functional methacrylate monomer. Curable materials in which R₁ is carboxylate and R₂ is hydrogen or methyl are collectively referred to herein as “(meth)acrylates”.

In some embodiments, R₁ is amide, and the compound is a mono-functional acrylamide monomer. In some of these embodiments, R₂ is methyl, and the compound is a mono-functional methacrylamide monomer. Curable materials in which R₁ is amide and R₂ is hydrogen or methyl are collectively referred to herein as “(meth)acrylamide”.

(Meth)acrylates and (meth)acrylamides are collectively referred to herein as (meth)acrylic materials.

When one or both of R₁ and R₂ comprise a polymeric or oligomeric moiety, the mono-functional curable compound of Formula I is an exemplary polymeric or oligomeric mono-functional curable material. Otherwise, it is an exemplary monomeric mono-functional curable material.

In multi-functional curable materials, the two or more polymerizable groups are linked to one another via a linking moiety, as described herein, which can be hydrophobic, hydrophilic, amphiphilic, elastomeric, and the like.

In some embodiments, a multifunctional material can be represented by Formula I as described herein, in which R₁ comprises a moiety that terminates by a polymerizable group, as described herein.

For example, a di-functional curable material can be represented by Formula I*:

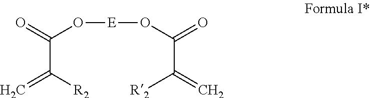

wherein E is a linking moiety as described herein, and R′₂ is as defined herein for R₂.

In another example, a tri-functional curable material can be represented by Formula II:

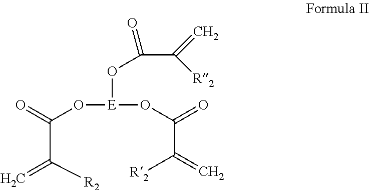

wherein E is a linking moiety as described herein, and R′₂ and R″₂ are each independently as defined herein for R₂.

In some embodiments, a multi-functional (e.g., di-functional, tri-functional or higher) curable material can be collectively represented by Formula III:

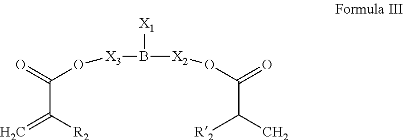

Wherein:
R₂ and R′₂ are as defined herein;
B is a di-functional or tri-functional branching unit as defined herein (depending on the nature of X₁);
X₂ and X₃ are each independently absent, or is selected from an alkyl, a hydrocarbon, an alkylene chain, a cycloalkyl, an aryl, an alkylene glycol, a urethane moiety, a poly(alkylene glycol) moiety, an elastomeric moiety, and any combination thereof; and
X₁ is absent or is selected from an alkyl, a hydrocarbon, an alkylene chain, a cycloalkyl, an aryl, an alkylene glycol, a poly(alkylene glycol) moiety, a urethane moiety, and an elastomeric moiety, each being optionally being substituted (e.g., terminated) by a meth(acrylate) moiety (O—C(═O) CR″₂═CH₂), and any combination thereof, or, alternatively, X₁ is:

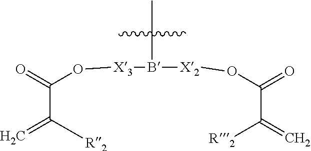

wherein:
the curved line represents the attachment point;
B′ is a branching unit, being the same as, or different from, B;
X′₂ and X′₃ are each independently as defined herein for X₂ and X₃; and
R″₂ and R″′₂ are as defined herein for R₂ and R′₂.

Multi-functional elastomeric curable materials featuring 4 or more polymerizable groups are also contemplated and can feature structures similar to those presented in Formula III, while including, for example, a branching unit B with higher branching, or including an X₁ moiety featuring two (meth)acrylate moieties as defined herein, or similar to those presented in Formula II, while including, for example, another (meth)acrylate moiety that is attached to the elastomeric moiety.

In some embodiments, the elastomeric moiety, e.g., Ra in Formula I or the moiety denoted as E in Formulae I*, II and III, is or comprises an alkyl, which can be linear or branched, and which is preferably of 3 or more or of 4 or more carbon atoms; an alkylene chain, preferably of 3 or more or of 4 or more carbon atoms in length; an alkylene glycol as defined herein, an oligo(alkylene glycol), or a poly(alkylene glycol), as defined herein, preferably of 4 or more atoms in length, a urethane, an oligourethane, or a polyurethane, as defined herein, preferably of 4 or more carbon atoms in length, and any combination of the foregoing.

### Component A

According to some of any of the embodiments described herein, the formulation comprises at least one curable, mono-functional, hydrophobic material featuring a low Tg, that is, Tg lower than 0° C., or lower than −10, or lower than −20, or lower than −30, or lower than −40, ° C., or of from 0 to −80, or from −10 to −80, or from −20 to −80, or from −20 to −60, or from −30 to −60, or from −40 to −60, ° C., including any intermediate values and subranges therebetween. The one or more components according to these embodiments are collectively referred to herein as Component A.

According to some of any of the embodiments described herein, Component A is a (meth)acrylic compound, and in some embodiments it is a (meth)acrylate, preferably acrylate.

According to some of any of the embodiments described herein, Component A comprises a linear aliphatic moiety, preferably an alkyl, more preferably an alkyl of at least 4, at least 5, or 6 carbon atoms in length, for example of from 4 to 20, or from 6 to 20, or from 8 to 20, carbon atoms in length, including any intermediate values and subranges therebetween.

According to some of any of the embodiments described herein, Component A is a (meth)acrylic compound, and in some embodiments it is a (meth)acrylate, preferably acrylate, as presented in Formula I, wherein Ra is a linear aliphatic moiety, preferably an alkyl, more preferably an alkyl of at least 4, at least 5, or 6 carbon atoms in length, for example of from 4 to 30, or from 6 to 30, or from 8 to 30, or from 4 to 20, or from 6 to 20, or from 8 to 20, carbon atoms in length, including any intermediate values and subranges therebetween.

Alternatively, Component A is a (meth)acrylic compound, and in some embodiments it is a (meth)acrylate, preferably acrylate, as presented in Formula I, and Ra is a hydrophobic moiety.

Exemplary commercially available curable, mono-functional hydrophobic materials featuring low Tg as described herein include, but are not limited to, Octyldecyl acrylate, and Tridecyl acrylate, such as those marketed under the tradenames SR-484 and SR-489.

According to some of any of the embodiments described herein, a total amount of the one or more curable, mono-functional, hydrophobic material(s) featuring Tg lower than 0° C. (Component A) is at least 10% by weight of the total weight of the formulation, and can range, for example, from 10 to 20, % by weight of the total weight of the formulation, including any intermediate value and subranges therebetween.

### Component B

According to the present embodiments, the curable formulation comprises at least one curable, mono-functional, hydrophobic material featuring low-medium Tg, which is also referred to herein as, for example, Component B. According to some embodiments, the curable formulation comprises at least one curable, mono-functional, hydrophobic material featuring Tg of from 0 to 100, or from 20 to 100, or from 20 to 80, or from 20 to 60, or from 20 to 50, ° C., including any intermediate values and subranges therebetween (e.g., Component B).

According to some of any of the embodiments described herein, a material denoted herein as Component B is a (meth)acrylic compound, and in some embodiments it is a (meth)acrylate, preferably acrylate, as presented in Formula I, with Ra being a hydrophobic moiety as described herein that imparts the material with a Tg as indicated. Exemplary such materials are those featuring as Ra an alicyclic moiety, for example, an alicyclic moiety comprising one or more alicyclic rings, each of at least 5 or at least 6 carbon atoms, for example, of from 6 to 20, or from 6 to 15, carbon atoms, including any intermediate values and subranges therebetween.

According to some of any of the embodiments described herein, the one or more curable, mono-functional, hydrophobic materials featuring low-medium Tg (Component B) comprise two or more materials. In some of these embodiments, one of these materials is a curable, mono-functional, hydrophobic material featuring a viscosity higher than 10 centipoises at 25° C. (also referred to herein as Component B1), for example, a viscosity of from 10 to 40, or from 10 to 30, or from 10 to 25, centipoises, including any intermediate values and subranges therebetween. In some of these embodiments, one of these materials is curable, mono-functional, hydrophobic material featuring a viscosity lower than 10 centipoises at 25° C. (also referred to herein as Component B2), for example, a viscosity of from 1 to 10, or from 1 to 8, or from 2 to 8, or from 1 to 5, or from 2 to 6, or from 2 to 5, centipoises, including any intermediate values and subranges therebetween. In some of these embodiments, one of these materials is a curable, mono-functional, hydrophobic material featuring a viscosity higher than 10 centipoises at 25° C. (also referred to herein as Component B1), and another one of these materials is curable, mono-functional, hydrophobic material featuring a viscosity lower than 10 centipoises at 25° C. (also referred to herein as Component B2). In exemplary embodiments, each of the Component B1 and Component B2 comprises an alicyclic moiety (e.g., of at least 6 carbon atoms), as described herein in any of the respective embodiments.

According to some of any of the embodiments described herein, Component B1 comprises a bicyclic moiety or an alicyclic moiety of at least 8, at least 10 or at least 12, carbon atoms, which can be monocyclic, bicyclic or tricyclic.

According to some of any of the embodiments described herein, Component B2 comprises a monocyclic moiety or an alicyclic moiety of up to 8, or up to 7, or up to 6 carbon atoms, which can be monocyclic or bicyclic.

Exemplary commercially available curable, mono-functional hydrophobic materials featuring low-medium Tg as described herein for Component B1, include, but are not limited to, (octahydro-4,7-methano-1H-indenyl)methyl acrylate, such as marketed under the tradename SR-897. Any other materials are also contemplated.

Exemplary commercially available curable, mono-functional hydrophobic materials featuring low-medium Tg as described herein for Component B2, include, but are not limited to, cyclohexyl acrylates, for example, 3,3,5-Trimethylcyclohexyl acrylate, such as marketed under the tradename Genomer 1120 or SR-420. Any other materials are also contemplated.

According to some of any of the embodiments described herein, a weight ratio of the at least one curable, mono-functional, hydrophobic material featuring a viscosity higher than 10 centipoises at 25° C. (Component B1), and the at least one curable, mono-functional, hydrophobic material featuring a viscosity lower than 10 centipoises at 25° C. (Component B2), ranges from 2:1 to 1:2, and can range from 1.5:1 to 1:1.5, or from 1.4:1 to 1:1.4, or from 1.3:1 to 1:1.3, or from 1.2:1 or 1:1.2, or from 1:1 to 1:1.5, or from 1:1 to 1:1.4, or from 1:1 to 1:1.3, or from 1:1 to 1:1.2, including any intermediate values and subranges therebetween.

According to some of any of the embodiments described herein, a total amount of the at least one curable, mono-functional, hydrophobic material featuring Tg of from 0 to 100° C. (Component B) is at least 45, or at least 50, % by weight of the total weight of the formulation, and can, for example, in a range of from 45 to 60, or from 45 to 55, or from 50 to 60, or from 50 to 55, % by weight of the total weight of the formulation, including any intermediate values and subranges therebetween.

According to some of any of the embodiments described herein, an amount of the at least one curable, mono-functional, hydrophobic material featuring a viscosity higher than 10 centipoises at 25° C. (Component B1) ranges from 20 to 30, or from 35 to 30, % by weight of the total weight of the formulation, including any intermediate values and subranges therebetween.

According to some of any of the embodiments described herein, an amount of the at least one curable, mono-functional, hydrophobic material featuring a viscosity lower than 10 centipoises at 25° C. (Component B2), ranges from 25 to 35, % by weight of the total weight of the formulation, including any intermediate values and subranges therebetween.

Herein throughout, unless otherwise indicated, viscosity values are provided for a viscosity of a material or a formulation when measured at 25° C. on a Brookfield's viscometer. Measured values are provided in centipoise units, which correspond to mPa·second units.

Herein throughout, “Tg” of a material refers to glass transition temperature defined as the location of the local maximum of the E″ curve, where E″ is the loss modulus of the material as a function of the temperature.

Broadly speaking, as the temperature is raised within a range of temperatures containing the Tg temperature, the state of a material, particularly a polymeric material, gradually changes from a glassy state into a rubbery state.

Herein, “Tg range” is a temperature range at which the E″ value is at least half its value (e.g., can be up to its value) at the Tg temperature as defined above.

Without wishing to be bound to any particular theory, it is assumed that the state of a polymeric material gradually changes from the glassy state into the rubbery within the Tg range as defined above. The lowest temperature of the Tg range is referred to herein as Tg(low) and the highest temperature of the Tg range is referred to herein as Tg(high).

Herein throughout, whenever a curable material is defined by a property of a hardened material obtained therefrom, it is to be understood that this property is for a hardened material obtained from this curable material per se.

Herein throughout, whenever the phrase “weight percent”, or “% by weight” or “% wt.”, is indicated in the context of embodiments of a formulation (e.g., a modeling formulation), it is meant weight percent of the total weight of the respective uncured formulation.

### Component E

According to some of any of the embodiments described herein, the curable formulation comprises at least one material that provides a rubbery material when hardened, which is also referred to herein as Component E, and comprises at least one curable, multi-functional, hydrophobic elastomeric material.

Exemplary such materials include multi-functional curable materials that comprise a polybutadiene moiety and/or a urethane moiety.

According to some of any of the embodiments described herein, Component E comprises at least one material that comprises a polybutadiene moiety, as referred to herein for Component E1.

According to some of any of the embodiments described herein, Component E comprises at least one material that comprises two or more urethane (meth)acrylate moieties.

According to some embodiments, Component E comprises one or more di-functional materials that can be collectively represented by Formula I*, wherein E is or comprises a polybutadiene moiety, optionally linked to one or more urethane moieties to form a urethane acrylate moiety.

According to some embodiments, Component E comprises one or more materials that can be collectively represented by Formula I*, wherein E is or comprises a urethane moiety that forms a urethane di(meth)acrylate moieties.

According to some of any of the embodiments described herein, Component E comprises one or more hydrophobic materials that comprises a urethane di(methacrylate) moiety.

Exemplary commercially available curable, multi-functional, hydrophobic elastomeric materials that comprise a urethane di(meth)acrylate moiety or two urethane(meth)acrylate moieties include, but are not limited to, those marketed under the tradenames BR640D, BR641D, BR643, BRC4421 and BRC441D. According to some embodiments, Component E comprises one or more di-functional urethane acrylate that comprises a polybutadiene moiety, such as, but not limited to, those marketed under the tradenames BR640D, BR641D and/or BR643.

According to some of any of the embodiments described herein, a total amount of the at least one curable, multi-functional, hydrophobic elastomeric material(s) (Component E) is at least 20, or at least 25, %, by weight, of the total weight of the formulation, and can range, for example, from 20 to 30, or from 25 to 30, % by weight, of the total weight of the formulation, including any intermediate values and subranges therebetween.

### Additional Components

The curable elastomeric composition according to some of the present embodiments can further comprise one or more additional materials, in addition to the components referred to herein as Components A, B and E, and preferably also Component I, which can be included in order to improve the mechanical properties of the hardened elastomeric material.

These components can include, for example, curable, optionally multi-functional, materials, that affect the mechanical strength of the hardened material and/or the resilience the hardened material. According to some embodiments, the additional components are hydrophobic and/or amphiphilic components.

According to some of any of the embodiments described herein, in cases where one or more of the additional components is a hydrophilic curable material, an amount of such a component is lower than 10, or lower than 8, or lower than 5, % by weight of the total weight of the formulation.

According to some of any of the embodiments described herein, the curable formulation further comprises at least one curable, multi-functional (e.g., tri-functional), material featuring a medium to high Tg of from 50 to 150° C. (Component D). According to some of these embodiments, the material referred to herein as Component D is an amphiphilic curable multi-functional (e.g., tri-functional) material. Materials suitable for use as Component D can be elastomeric and/or non-elastomeric, and in some embodiments are non-elastomeric.

According to exemplary embodiments, Component D comprises an ethoxylated multi-functional (e.g., tri-functional) material, in which each of the ethoxylated moieties is a relatively short moiety, comprising one or two alkylene glycol moieties.

According to some of any of the embodiments described herein, an amount of the at least one curable, multi-functional, material featuring Tg of from 50 to 150 0° C. (Component D) ranges from 1 to 10, or from 1 to 5, % by weight, of the total weight of the formulation, including any intermediate values and subranges therebetween.

According to some of any of the embodiments described herein, the curable formulation further comprises one or more silicone-containing polymeric material, which are also referred to herein interchangeably as polymeric silicone material(s), and which are collectively referred to herein also as Component F.

According to some of these embodiments, a total amount of the silicone-containing polymeric material(s) (Component F) ranges from 1 to 20, or from 5 to 20, or from 1 to 10, or from 5 to 10, % by weight of total weight of the formulation, including any intermediate values and subranges therebetween.

The one or more silicone-containing polymeric materials can comprise one or more curable silicone-containing polymeric material(s) (referred to herein as Component F1), which can be mono-functional and/or multi-functional (e.g., di-functional) and/or one or more non-curable silicone-containing polymeric material (referred to herein as Component F2).

According to some of any of the embodiments described herein, the one or more silicone-containing polymeric material(s) are each amphiphilic or hydrophobic materials, preferably amphiphilic materials.

According to the present embodiments, the curable formulation comprises one or more polymeric silicone material(s), which are also referred to herein interchangeably as silicone-containing polymeric material(s).

According to some of any of the embodiments described herein, a total amount of the one or more polymeric silicone material(s) ranges from 5 to 20% by weight of the total weight of the formulation, including any intermediate values and subranges therebetween.

According to some of any of the embodiments described herein, a total amount of the one or more polymeric silicone material(s) ranges from 5 to 10% by weight of the total weight of the formulation, including any intermediate values and subranges therebetween.

According to some of any of the embodiments described herein, a total amount of the one or more polymeric silicone material(s) ranges from 5 to 15% by weight of the total weight of the formulation, including any intermediate values and subranges therebetween.

According to some of any of the embodiments described herein, a total amount of the one or more polymeric silicone material(s) ranges from 1 to 20% by weight of the total weight of the formulation, including any intermediate values and subranges therebetween.

According to some of any of the embodiments described herein, a total amount of the one or more polymeric silicone material(s) ranges from 1 to 10% by weight of the total weight of the formulation, including any intermediate values and subranges therebetween.

According to some of any of the embodiments described herein, a total amount of the one or more polymeric silicone material(s) ranges from 5 to 10% by weight of the total weight of the formulation, including any intermediate values and subranges therebetween.

According to some of any of the embodiments described herein, each of the one or more silicone-containing polymeric material(s) independently has a relatively low average molecular weight (MW), that is, lower than 8,000, preferably lower than 6,000, grams/mol, preferably in a range of from 500 to 8,000, or 500 to 7,000, or 50 to 6,000, or 1,000 to 8,000, or 1,000 to 7,000, or 1,000 to 6,000, or 1,000 to 5,000, or 2,000 to 8,000, or 2,000 to 7,000, or 2,000 to 6,000, or 2,000 to 5,000, or 1,000 to 5,000, or 3,000 to 6,000, including any intermediate values and subranges therebetween.

Silicone refers to polymeric or oligomeric siloxane (polysiloxane), typically polydimethylsiloxane (PDMS), or otherwise non-substituted polysiloxane or polysiloxane substituted by other alkyls, cycloalkyls and/or aryls.

The silicone-containing polymeric materials comprise silicone, as described herein, for example, PDMS, which can be modified at one or more of its termini and/or be substituted at one or more Si atoms. When the silicone-containing polymeric material is modified or substituted by a polymeric moiety, it is considered as a copolymer. When the silicone-containing polymeric material is modified or substituted by a moiety that comprises one or more curable groups, it is considered as a curable material.

Silicone polyether typically refers to polymeric or oligomeric siloxane as described herein, substituted at one or both termini by a polyether such as PEG.

Silicone polyester typically refers to polymeric or oligomeric siloxane as described herein, coupled to a polyester, at one or more positions. The silicone portion can feature one or more curable groups.

Silicone acrylate/methacrylate/urethane acrylate typically refers to polymeric or oligomeric siloxane as described herein, substituted at one or both termini by the respective curable acrylate or urethane acrylate group.

According to some of any of the embodiments described herein, the curable polymeric silicone material can be a mono-functional or a multi-functional polymeric silicone material.

According to some embodiments, the curable polymeric silicone material is a multi-functional curable and is preferably a di-functional polymeric silicone material.

According to some of any of the embodiments described herein, the curable polymeric silicone material is a UV-curable material, featuring one or more, preferably two, UV-curable groups as described herein. In some embodiments, the curable polymeric silicone material comprises one or more, preferably two, (meth)acrylate curable groups.

According to some of any of the embodiments described herein, the curable polymeric silicone material comprises two (meth)acrylate curable groups, is an amphiphilic material, and features an average MW as described herein.

Exemplary such materials include, for example, silicone polyester acrylates, as described herein, such as silicone polyester di-(meth)acrylate, also referred to herein as Silicone A. Exemplary such materials also include di-functional silicone urethane (meth)acrylate (silicone urethane di(meth)acrylate), also referred to herein as Silicone B. Exemplary such commercially available materials are those marketed under the tradenames SIP910 and SIU100.

Additional examples include silicone di-(meth)acrylates, such as, for example, those marketed under the tradenames Silmer® ACRDi2510; Silmer ACR® Di1010; and Silmer® ACR Di1508. Any other materials featuring the above-mentioned characteristics are contemplated.

Non-curable silicone-containing materials can include silicone by itself, yet, preferably include silicone which is modified at one or more of its termini and/or substituted at one or more of its Si atoms, by an amphiphilic moiety. In some embodiments, the amphiphilic moiety is a polymeric moiety, and the silicone-containing polymeric material is a co-polymer.

In exemplary embodiments, a non-curable silicone comprises one or more polyether moieties attached to one or more of its termini, and is a silicone polyether. In exemplary embodiments, the polyether is a poly(alkylene glycol), for example, poly(ethylene glycol). The one or more polyether moieties in a silicone polyether can independent comprise 2, 3, 4, 5, 6, 7, preferably 8, 9, 10, or more, alkylene glycol units, as long as the MW as defined herein is kept. Exemplary silicone polyethers that are usable as non-curable silicone-containing polymeric materials are commercially available under the tradename Silsurf®, and include, for example, Silsurf® A010-D and Silsurf® C208. Any other materials are contemplated.

An elastomeric formulation according to the present embodiments can include one type of silicone-containing polymeric material or a combination of one or more silicone-containing polymeric materials.

According to some of any of the embodiments described herein, the formulation comprises one or more curable polymeric silicone material(s) and one or more non-curable polymeric silicone material(s), each as described herein in any of the respective embodiments and any combination thereof.

According to some of these embodiments, a weight ratio of the curable polymeric silicone material(s) and the non-curable polymeric silicone material(s) ranges from 5:1 to 1:5, or from 2:1 to 1:2, including any intermediate values and subranges therebetween.

The type and amount of the silicone-containing polymeric material, and a weight ratio in case two or more materials are combined, can be determined in accordance with the elastomeric formulation in which it is included.

According to some embodiments, the polymeric silicone material comprises at least one non-curable polymeric silicone material, in an amount of 1 to 10, or 2 to 10, or 5 to 10, preferably 5, % by weight of the total weight of the formulation.

According to some embodiments, the polymeric silicone material comprises at least one non-curable polymeric silicone material and at least one curable polymeric silicone material.

According to some of these embodiments, a weight ratio of the at least one curable polymeric silicone material and the at least one non-curable polymeric silicone material ranges from 5:1 to 1:5, or from 2:1 to 1:2, preferably from 5:1 to 1:1, or from 2:1 to 1:1, including any intermediate values and subranges therebetween.

According to some of any of the embodiments described herein, the curable formulation further comprises a curable material that comprises at least two hydrogen bond-forming groups, such as, for example, a (meth)acrylamide, preferably a methacrylamide, which is also referred to herein as Component MA.

According to some of any of the embodiments described herein, a concentration of the curable material that comprises at least two hydrogen bond-forming groups ranges from 1 to 10%, or from 1 to 5%, or from 1 to 3%, or from 1.5 to 2%, by weight, of the total weight of the formulation.

As used herein and known in the art, a “hydrogen bond” is a non-covalent bond that forms a type of dipole-dipole attraction which occurs when a hydrogen atom bonded to a strongly electronegative atom exists in the vicinity of another electronegative atom with a lone pair of electrons.

The hydrogen atom in a hydrogen bond is partly shared between two relatively electronegative atoms.

According to some of any of the embodiments described herein, a curable material that effects cross-linking via hydrogen bonds comprises at least one, preferably at least two, hydrogen bond-forming group.

The phrase “hydrogen bond-forming group”, as used herein, describes a moiety, or group, or atom, which is capable of forming hydrogen bonds by being a hydrogen bond donor and/or a hydrogen bond acceptor. Certain groups can include both a hydrogen bond donor and a hydrogen bond acceptor and as such can effect or establish cross-linking.

A hydrogen-bond donor, which is also referred to herein as a hydrogen bond-forming donor group, is a group that includes both the atom to which the hydrogen is more tightly linked and the hydrogen atom itself, whereas a hydrogen-bond acceptor, which is also referred to herein as a hydrogen bond-forming acceptor group, is an electronegative atom capable of being linked to a hydrogen atom of another group. The relatively electronegative atom to which the hydrogen atom is covalently bonded pulls electron density away from the hydrogen atom so that it develops a partial positive charge (δ⁺). Thus, it can interact with an atom having a partial negative charge (δ⁻) through an electrostatic interaction.

Atoms that typically participate in hydrogen bond interactions, as donors and/or acceptors, include oxygen, nitrogen and fluorine. These atoms typically form a part of a chemical group or moiety such as, for example, carbonyl, carboxylate, amide, hydroxyl, amine, imine, carbamate, alkylfluoride, F₂, and more. However, other electronegative atoms and chemical groups or moieties containing same may participate in hydrogen bonding.

Exemplary hydrogen bond-forming groups include, but are not limited to, amide, carboxylate, hydroxy, alkoxy, aryloxy, ether, amine, carbamate, hydrazine, a nitrogen-containing heteroalicyclic (e.g., piperidine, oxalidine), nitrile, and an oxygen-containing heteroalicyclic (e.g., tetrahydrofuran, morpholine), and any other chemical moiety that comprises one or more nitrogen and/or oxygen atoms.

According to some of any of the embodiments described herein, a preferred material is such that is capable of forming at least two hydrogen bonds, for example, by featuring one or more hydrogen bond forming groups that comprise two groups of a hydrogen donor group and/or a hydrogen acceptor group.

In some embodiments, the hydrogen bond-forming curable material comprises one or more hydrogen bond-forming groups selected from an amide group, and a carbamate group, each of which features a hydrogen donor group (—NH—) and a hydrogen acceptor group or atom (═O).

According to some of any of the embodiments described herein, a preferred material is such that features at least one hydrogen bond-forming donor group which is an amine group (e.g., an amine that forms a part of an amide or a carbamate).

According to some of any of the embodiments described herein, a preferred material is such that features at least one hydrogen bond-forming donor group and at least one hydrogen bond-forming acceptor group. Preferably, each of the donor group(s) and the acceptor group(s) are separated from one another by no more than 2 atoms, or no more than 1 atom. An exemplary such hydrogen-bond forming group is an amide, which can be either unsubstituted or substituted by a group that does not contain a hydrogen bond-forming group.

In some embodiments, the hydrogen bond-forming curable material is such that a ratio between the number of hydrogen bond-forming groups and its molecular weight is higher than 0.02, and is, for example, 0.025, 0.030, 0.035, etc., for example, from 0.02 to 0.05, or from 0.03 to 0.05, or from 0.04 to 0.05, of from 0.03 to 0.04, including any intermediate values and subranges therebetween.

In some of any of the embodiments described herein, the hydrogen bond-forming curable material comprises one or more amide groups, and in some embodiments, it is a (meth)acrylamide (encompassing acrylamide and methacrylamide), preferably a methacrylamide. A methacrylamide is preferred for being less reactive (its rate of polymerization is lower compared to acrylamide).

The (meth)acrylamide is preferably unsubstituted. When substituted, the substituent is preferably incapable of forming hydrogen bonds, that is, the substituent does not contain a hydrogen bond-forming group as defined herein.

### Exemplary Formulations

In some of any of the embodiments described herein, each of the elastomeric curable materials in the curable formulation is a UV curable material, and in some embodiments, it is an elastomeric (meth)acrylate, for example, an elastomeric acrylate.

In some of any of the embodiments described herein, each of the additional non-elastomeric curable materials in the formulation is a UV-curable acrylate or methacrylate.

In some of any of the embodiments described herein, the curable elastomeric formulation comprises one or more mono-functional hydrophobic elastomeric acrylate(s) featuring low Tg as described herein (Component A), two or more mono-functional hydrophobic elastomeric acrylate(s) featuring low-medium Tg as described herein (Component B1 and B2), and one or more multi-functional (e.g., di-functional) elastomeric acrylate or methacrylate as described herein, preferably comprising a polybutadiene moiety (Component E).

According to some of any of the embodiments described herein, a weight ratio of a total amount of the at least one curable, multi-functional, hydrophobic elastomeric material (Component E) and a total amount of the at least one curable, mono-functional hydrophobic material featuring Tg of from 0 to 100° C. (Component B) ranges from 1:1 to 1:2, including any intermediate values and subranges therebetween.

According to some of any of the embodiments described herein, a weight ratio of a total amount of the at least one curable, multi-functional, hydrophobic elastomeric material (Component E) and a total amount of the at least one curable, mono-functional, hydrophobic material featuring Tg lower than 0° C. (Component A) ranges from 1:1 to 2:1, including any intermediate values and subranges therebetween.

According to some of any of the embodiments described herein, a weight ratio of a total amount of the at least one curable, mono-functional, hydrophobic material featuring Tg of from 0 to 100° C. (Component B) and a total amount of the at least one curable, mono-functional, hydrophobic material featuring Tg lower than 0° C. (Component A) ranges from 2:1 to 3:1, including any intermediate values and subranges therebetween.

In some of any of the embodiments described herein, the curable elastomeric formulation comprises:
one or more mono-functional hydrophobic elastomeric acrylate(s) as described herein (Component A), preferably a mono-functional aliphatic acrylate as described herein, at a total concentration that ranges from about 20 to about 30, % by weight, of the total weight of the formulation, including any intermediate values and subranges therebetween;
one or more multi-functional elastomeric acrylate(s) as described herein (Component E), preferably a multi-functional (e.g., di-functional) urethane acrylate that comprises a polybutadiene moiety, at a total concentration that ranges from about 20 to about 40, or from about 20 to about 35, or from about 25 to about 35, or from about 20 to about 30, or from about 25 to about 30, % by weight, of the total weight of the formulation, including any intermediate values and subranges therebetween; and
one or more, preferably two or more, hydrophobic mono-functional acrylate or methacrylate featuring low-medium Tg as described herein (Component B), at a total concentration that ranges from about 45 to about 65, or from about 50 to about 65, or from about 50 to about 60, % by weight of the total weight of the formulation, including any intermediate values and subranges therebetween.

According to some of any of the embodiments described herein, the curable elastomeric formulation is devoid of silica particles, or comprises silica particles in an amount of no more than 3%, or no more than 2%, or no more than 1%, of the total weight of the formulation.

### Non-Curable Components:

In some of any of the embodiments described herein, the curable elastomeric formulation further comprises an initiator, for initiating polymerization of the curable materials.

When all the curable materials (elastomeric and additional) are photopolymerizable (e.g., UV-curable), a photoinitiator is usable in these embodiments.

Non-limiting examples of suitable photoinitiators include benzophenones (aromatic ketones) such as benzophenone, methyl benzophenone, Michler's ketone and xanthones; acylphosphine oxide type photo-initiators such as 2,4,6-trimethylbenzolydiphenyl phosphine oxide (TMPO), 2,4,6-trimethylbenzoylethoxyphenyl phosphine oxide (TEPO), and bisacylphosphine oxides (BAPO's); benzoins and bezoin alkyl ethers such as benzoin, benzoin methyl ether and benzoin isopropyl ether and the like. Examples of photoinitiators are alpha-amino ketone, bisacylphosphine oxide (BAPO's), and those marketed under the tradename Irgacure®.

A photo-initiator may be used alone or in combination with a co-initiator. Benzophenone is an example of a photoinitiator that requires a second molecule, such as an amine, to produce a free radical. After absorbing radiation, benzophenone reacts with a ternary amine by hydrogen abstraction, to generate an alpha-amino radical which initiates polymerization of acrylates. Non-limiting example of a class of co-initiators are alkanolamines such as triethylamine, methyldiethanolamine and triethanolamine.

According to some embodiments, the photoinitiator is, for example, of the Irgacure® family.

A concentration of a photoinitiator in a formulation containing same may range from about 0.1 to about 5% by weight, or from about 1 to about 3%, or from about 0.5 to 2.5, or from about 1 to 2, % by weight, of the total weight of the formulation, including any intermediate value and subranges therebetween.

According to some of any of the embodiments described herein, one or more of the modeling material formulation(s) further comprises one or more additional, non-curable material, for example, one or more of a colorant (a dye and/or a pigment), a dispersant, a surfactant, a stabilizer, a plasticizer, an anti-oxidant, and an inhibitor.

An inhibitor is included in the formulation for preventing or slowing down polymerization and/or curing prior to exposing to the curing condition. Commonly used inhibitors, such as radical inhibitors, are contemplated.

In any of the exemplary modeling material formulations described herein, a concentration of an inhibitor ranges from 0 to about 2% weight, or from 0 to about 1%, and is, for example, 0, 0.1, 0.2, 0.3, 0.4, 0.5, 0.6, 0.7, 0.8, 0.9 or about 1%, by weight, including any intermediate value therebetween, of the total weight of the formulation or a formulation system comprising same.

Commonly used surfactants, dispersants, colorants, anti-oxidants and stabilizers are contemplated. Exemplary concentrations of each component, if present, range from about 0.01 to about 1, or from about 0.01 to about 0.5, or from about 0.01 to about 0.1, weight percent, of the total weight of the formulation containing same.

Commonly used plasticizers are contemplated, and preferred are slow-evaporating (featuring a low evaporation rate, e.g., lower than 1 or lower than 0.5, compared to n-butyl acetate as the reference material) plasticizers, such as, for example, alkylene glycols alkyl ethers (e.g., dipropylene glycol mono-n-butyl ether, dipropylene glycol mono-methyl ether, and like materials). Without being bound by any particular theory, it is assumed and has been demonstrated (data not shown) that such plasticizers advantageously affect (that is, reduce) the Shore hardness of the hardened material without adversely affecting other mechanical properties. In some embodiments, when a plasticizer is added, the Shore hardness value of the hardened material is reduced by 10%, or by 20%, or by 25%, or even more, compared to the same formulation without a plasticizer.

A plasticizer as described herein, if present, is in an amount that ranges from about 0.01 to about 5, or from about 0.01 to about 2, or from about 0.01 to about 1, or from about 0.1 to about 5, or from about 0.1 to about 2, or from about 0.1 to about 1, or from about 0.5 to about 5, or from about 0.5 to about 3, or from about 0.5 to about 2, or from 0.5 to about 1.5, % by weight, of the total weight of a formulation containing same.

In any of the exemplary modeling material formulations described herein, a concentration of a surfactant ranges from 0 to about 1% weight, and is, for example, 0, 0.01, 0.05, 0.1, 0.5 or about 1%, by weight, including any intermediate value therebetween, of the total weight of the formulation or formulation system comprising same.

In any of the exemplary modeling material formulations described herein, a concentration of a dispersant ranges from 0 to about 2% weight, and is, for example, 0, 0.1, 0.5, 0.7, 1, 1.2, 1.3, 1.35, 1.4, 1.5, 1.7, 1.8 or about 2%, by weight, including any intermediate value therebetween, of the total weight of the formulation or formulation system comprising same.

### The Method:

According to an aspect of some embodiments of the present invention there is provided a method of additive manufacturing of a three-dimensional object, as described herein. The method of the present embodiments is usable for manufacturing an object having, in at least a portion thereof, an elastomeric material, as defined herein.

The method is generally effected by sequentially forming a plurality of layers in a configured pattern corresponding to the shape of the object, such that formation of each of at least a few of said layers, or of each of said layers, is formed of a building material (uncured) which comprises one or more modeling material formulation(s), and exposing the modeling material to a curing condition, preferably a curing energy (e.g., irradiation) to thereby form, in a layer-wise manner, a cured modeling material, as described in further detail hereinafter.

In some exemplary embodiments of the invention an object is manufactured by using a building material (uncured) that comprises two or more different modeling material formulations, for example, as described hereinbelow. In some of these embodiments, each modeling material formulation is dispensed from a different array of nozzles belonging to the same or distinct dispensing heads of the inkjet printing apparatus, as described herein.

In some embodiments, two or more such arrays of nozzles that dispense different modeling material formulations are both located in the same printing head of the AM apparatus (i.e. multi-channels printing head). In some embodiments, arrays of nozzles that dispense different modeling material formulations are located in separate printing heads, for example, a first array of nozzles dispensing a first modeling material formulation is located in a first printing head, and a second array of nozzles dispensing a second modeling material formulation is located in a second printing head.

In some embodiments, an array of nozzles that dispense a modeling material formulation and an array of nozzles that dispense a support material formulation are both located in the same printing head. In some embodiments, an array of nozzles that dispense a modeling material formulation and an array of nozzles that dispense a support material formulation are located in separate printing heads.

The modeling material formulations are optionally and preferably deposited in layers during the same pass of the printing heads. The modeling material formulations and/or combination of formulations within the layer are selected according to the desired properties of the object, and as further described in detail hereinbelow. Such a mode of operation is also referred to herein as “multi-material”, as described herein.

In some of any of the embodiments of the present invention, once a layer is dispensed as described herein, exposure to a curing condition (e.g., curing energy) as described herein is effected. In some embodiments, the curable materials are photocurable material, preferably UV-curable materials, and the curing condition is such that a radiation source emits UV radiation.

In some of any of the embodiments described herein, the UV irradiation is from a LED source, as described herein.

In some of any of the embodiments described herein, the curing condition comprises electromagnetic irradiation and said electromagnetic irradiation is from a LED source.

In some of any of the embodiments described herein, the curing condition comprises UV irradiation.

In some of any of the embodiments described herein, a dose of the UV irradiation is higher than 0.1 J/cm² per layer, e.g., as described herein.

In some embodiments, where the building material comprises also support material formulation(s), the method proceeds to removing the hardened support material (e.g., thereby exposing the adjacent hardened modeling material). This can be performed by mechanical and/or chemical means, as would be recognized by any person skilled in the art. A portion of the support material may optionally remain upon removal, for example, within a hardened mixed layer, as described herein.

In some embodiments, removal of hardened support material reveals a hardened mixed layer, comprising a hardened mixture of support material and modeling material formulation. Such a hardened mixture at a surface of an object may optionally have a relatively non-reflective appearance, also referred to herein as “matte”; whereas surfaces lacking such a hardened mixture (e.g., wherein support material formulation was not applied thereon) are described as “glossy” in comparison.

In some of any of the embodiments described herein, the method further comprises exposing the cured modeling material, either before or after (preferably after) removal of a support material, if such has been included in the building material, to a post-treatment condition.

In some of any of the embodiments of this aspect of the present invention, for at least a few of the dispensed layers, the dispensing is of a curable elastomeric formulation as described herein in any of the respective embodiments and any combination thereof.

In some of any of the embodiments described herein, the dispensing temperature, that is, the temperature of the environment of the system where the dispensing takes place, is lower than 40 or lower than 35° C.

### The System:

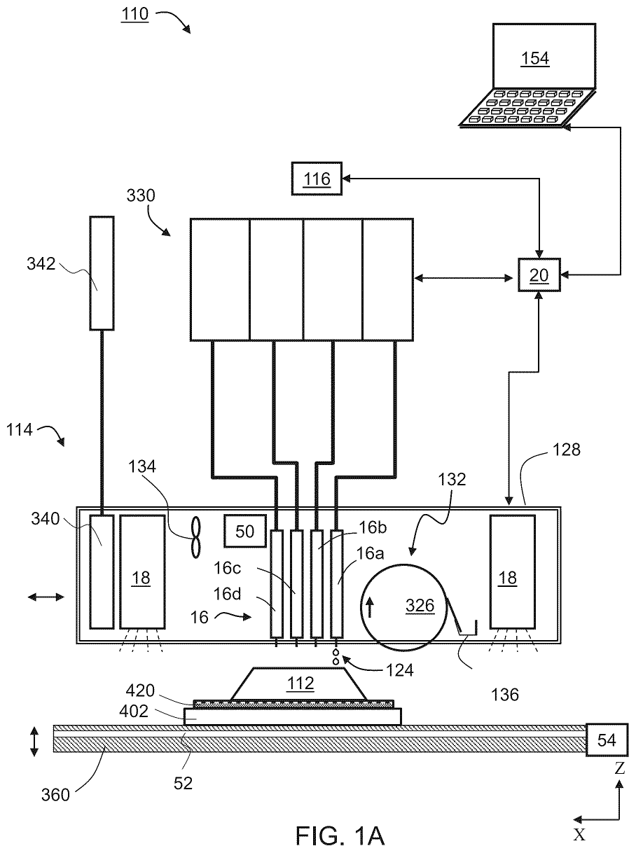

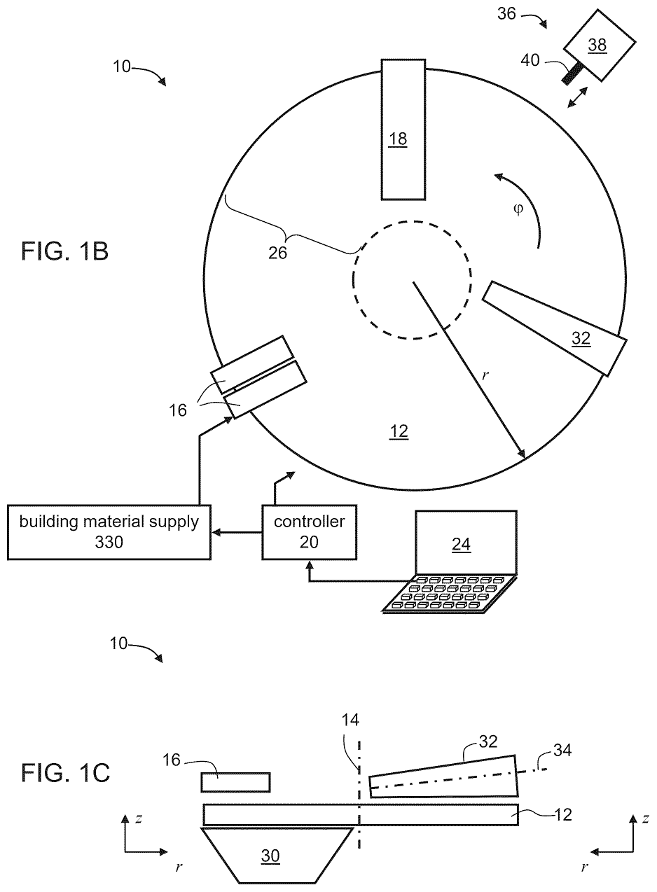

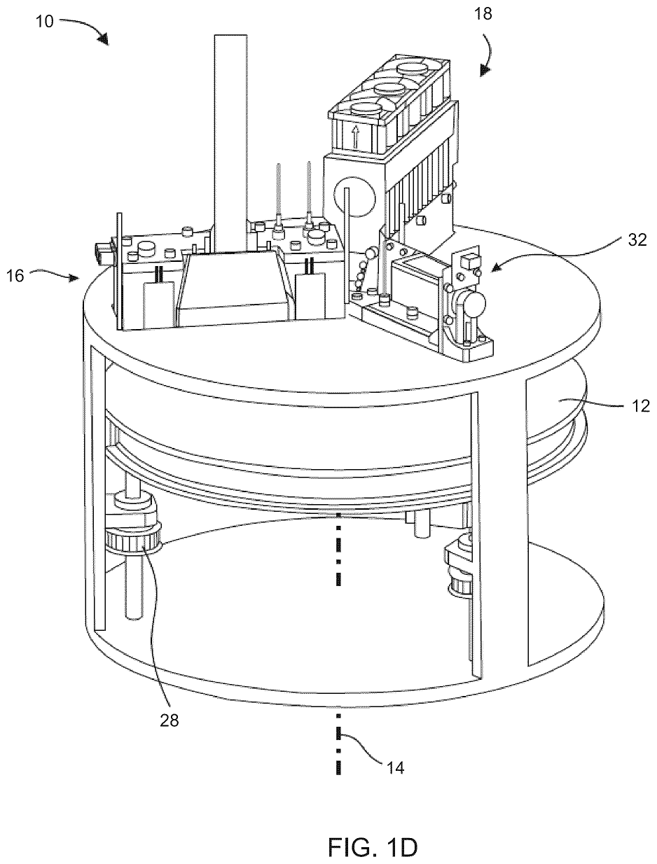

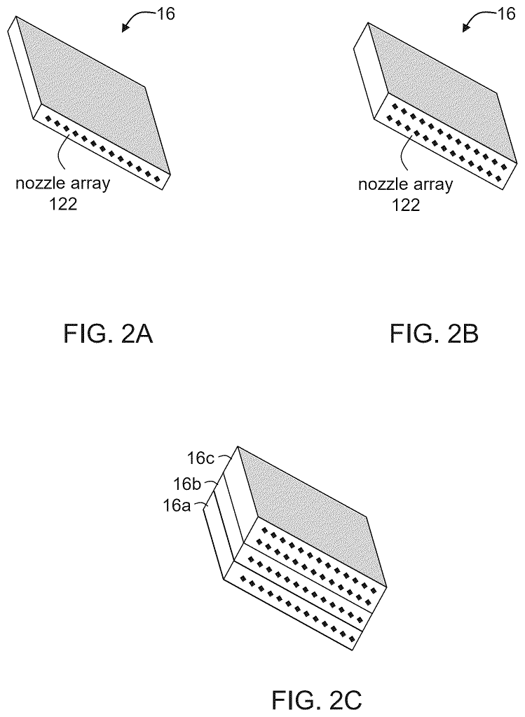

A representative and non-limiting example of a system 110 suitable for AM of an object 112 according to some embodiments of the present invention is illustrated in FIG. 1A. System 110 comprises an additive manufacturing apparatus 114 having a dispensing unit 16 which comprises a plurality of printing heads. Each head preferably comprises one or more arrays of nozzles 122, typically mounted on an orifice plate 121, as illustrated in FIGS. 2A-C described below, through which a liquid building material formulation 124 is dispensed.

Preferably, but not obligatorily, apparatus 114 is a three-dimensional printing apparatus, in which case the printing heads are printing heads, and the building material formulation is dispensed via inkjet technology. This need not necessarily be the case, since, for some applications, it may not be necessary for the additive manufacturing apparatus to employ three-dimensional printing techniques. Representative examples of additive manufacturing apparatus contemplated according to various exemplary embodiments of the present invention include, without limitation, fused deposition modeling apparatus and fused material formulation deposition apparatus.

Each printing head is optionally and preferably fed via one or more building material formulation reservoirs which may optionally include a temperature control unit (e.g., a temperature sensor and/or a heating device), and a material formulation level sensor. To dispense the building material formulation, a voltage signal is applied to the printing heads to selectively deposit droplets of material formulation via the printing head nozzles, for example, as in piezoelectric inkjet printing technology. Another example includes thermal inkjet printing heads. In these types of heads, there are heater elements in thermal contact with the building material formulation, for heating the building material formulation to form gas bubbles therein, upon activation of the heater elements by a voltage signal. The gas bubbles generate pressures in the building material formulation, causing droplets of building material formulation to be ejected through the nozzles. Piezoelectric and thermal printing heads are known to those skilled in the art of solid freeform fabrication. For any types of inkjet printing heads, the dispensing rate of the head depends on the number of nozzles, the type of nozzles and the applied voltage signal rate (frequency).

Preferably, but not obligatorily, the overall number of dispensing nozzles or nozzle arrays is selected such that half of the dispensing nozzles are designated to dispense support material formulation and half of the dispensing nozzles are designated to dispense modeling material formulation, i.e. the number of nozzles jetting modeling material formulations is the same as the number of nozzles jetting support material formulation. In the representative example of FIG. 1A, four printing heads 16a, 16b, 16c and 16d are illustrated. Each of heads 16a, 16b, 16c and 16d has a nozzle array. In this Example, heads 16a and 16b can be designated for modeling material formulation/s and heads 16c and 16d can be designated for support material formulation. Thus, head 16a can dispense one modeling material formulation, head 16b can dispense another modeling material formulation and heads 16c and 16d can both dispense support material formulation. In an alternative embodiment, heads 16c and 16d, for example, may be combined in a single head having two nozzle arrays for depositing support material formulation. In a further alternative embodiment any one or more of the printing heads may have more than one nozzle arrays for depositing more than one material formulation, e.g. two nozzle arrays for depositing two different modeling material formulations or a modeling material formulation and a support material formulation, each formulation via a different array or number of nozzles.

Yet it is to be understood that it is not intended to limit the scope of the present invention and that the number of modeling material formulation printing heads (modeling heads) and the number of support material formulation printing heads (support heads) may differ. Generally, the number of arrays of nozzles that dispense modeling material formulation, the number of arrays of nozzles that dispense support material formulation, and the number of nozzles in each respective array are selected such as to provide a predetermined ratio, a, between the maximal dispensing rate of the support material formulation and the maximal dispensing rate of modeling material formulation. The value of the predetermined ratio, a, is preferably selected to ensure that in each formed layer, the height of modeling material formulation equals the height of support material formulation. Typical values for a are from about 0.6 to about 1.5.

As used herein throughout the term “about” refers to ±10%.

For example, for a=1, the overall dispensing rate of support material formulation is generally the same as the overall dispensing rate of the modeling material formulation when all the arrays of nozzles operate.

Apparatus 114 can comprise, for example, M modeling heads each having m arrays of p nozzles, and S support heads each having s arrays of q nozzles such that M×m×p=S×s×q. Each of the M×m modeling arrays and S×s support arrays can be manufactured as a separate physical unit, which can be assembled and disassembled from the group of arrays. In this embodiment, each such array optionally and preferably comprises a temperature control unit and a material formulation level sensor of its own, and receives an individually controlled voltage for its operation.

Apparatus 114 can further comprise a solidifying device 324 which can include any device configured to emit light, heat or the like that may cause the deposited material formulation to harden. For example, solidifying device 324 can comprise one or more radiation sources, which can be, for example, an ultraviolet or visible or infrared lamp, or other sources of electromagnetic radiation, or electron beam source, depending on the modeling material formulation being used. In some embodiments of the present invention, solidifying device 324 serves for curing or solidifying the modeling material formulation.

In addition to solidifying device 324, apparatus 114 optionally and preferably comprises an additional radiation source 328 for solvent evaporation. Radiation source 328 optionally and preferably generates infrared radiation. In various exemplary embodiments of the invention solidifying device 324 comprises a radiation source generating ultraviolet radiation, and radiation source 328 generates infrared radiation.

In some embodiments of the present invention apparatus 114 comprises cooling system 134 such as one or more fans or the like

The printing head(s) and radiation source are preferably mounted in a frame or block 128 which is preferably operative to reciprocally move over a tray 360, which serves as the working surface. In some embodiments of the present invention the radiation sources are mounted in the block such that they follow in the wake of the printing heads to at least partially cure or solidify the material formulations just dispensed by the printing heads. Tray 360 is positioned horizontally. According to the common conventions an X-Y-Z Cartesian coordinate system is selected such that the X-Y plane is parallel to tray 360. Tray 360 is preferably configured to move vertically (along the Z direction), typically downward. In various exemplary embodiments of the invention, apparatus 114 further comprises one or more leveling devices 132, e.g. a roller 326. Leveling device 326 serves to straighten, level and/or establish a thickness of the newly formed layer prior to the formation of the successive layer thereon. Leveling device 326 preferably comprises a waste collection device 136 for collecting the excess material formulation generated during leveling. Waste collection device 136 may comprise any mechanism that delivers the material formulation to a waste tank or waste cartridge.

In use, the printing heads of unit 16 move in a scanning direction, which is referred to herein as the X direction, and selectively dispense building material formulation in a predetermined configuration in the course of their passage over tray 360. The building material formulation typically comprises one or more types of support material formulation and one or more types of modeling material formulation. The passage of the printing heads of unit 16 is followed by the curing of the modeling material formulation(s) by radiation source 126. In the reverse passage of the heads, back to their starting point for the layer just deposited, an additional dispensing of building material formulation may be carried out, according to predetermined configuration. In the forward and/or reverse passages of the printing heads, the layer thus formed may be straightened by leveling device 326, which preferably follows the path of the printing heads in their forward and/or reverse movement. Once the printing heads return to their starting point along the X direction, they may move to another position along an indexing direction, referred to herein as the Y direction, and continue to build the same layer by reciprocal movement along the X direction. Alternately, the printing heads may move in the Y direction between forward and reverse movements or after more than one forward-reverse movement. The series of scans performed by the printing heads to complete a single layer is referred to herein as a single scan cycle.

Once the layer is completed, tray 360 is lowered in the Z direction to a predetermined Z level, according to the desired thickness of the layer subsequently to be printed. The procedure is repeated to form three-dimensional object 112 in a layer-wise manner.

In another embodiment, tray 360 may be displaced in the Z direction between forward and reverse passages of the printing head of unit 16, within the layer. Such Z displacement is carried out in order to cause contact of the leveling device with the surface in one direction and prevent contact in the other direction.

System 110 optionally and preferably comprises a building material formulation supply system 330 which comprises the building material formulation containers or cartridges and supplies a plurality of building material formulations to fabrication apparatus 114.

A control unit 152 controls fabrication apparatus 114 and optionally and preferably also supply system 330. Control unit 152 typically includes an electronic circuit configured to perform the controlling operations. Control unit 152 preferably communicates with a data processor 154 which transmits digital data pertaining to fabrication instructions based on computer object data, e.g., a CAD configuration represented on a computer readable medium in a form of a Standard Tessellation Language (STL) format or the like. Typically, control unit 152 controls the voltage applied to each printing head or each nozzle array and the temperature of the building material formulation in the respective printing head or respective nozzle array.

Once the manufacturing data is loaded to control unit 152 it can operate without user intervention. In some embodiments, control unit 152 receives additional input from the operator, e.g., using data processor 154 or using a user interface 116 communicating with unit 152. User interface 116 can be of any type known in the art, such as, but not limited to, a keyboard, a touch screen and the like. For example, control unit 152 can receive, as additional input, one or more building material formulation types and/or attributes, such as, but not limited to, color, characteristic distortion and/or transition temperature, viscosity, electrical property, magnetic property. Other attributes and groups of attributes are also contemplated.

Another representative and non-limiting example of a system 10 suitable for AM of an object according to some embodiments of the present invention is illustrated in FIGS. 1B-D. FIGS. 1B-D illustrate a top view (FIG. 1B), a side view (FIG. 1C) and an isometric view (FIG. 1D) of system 10.

In the present embodiments, system 10 comprises a tray 12 and a plurality of inkjet printing heads 16, each having one or more arrays of nozzles with respective one or more pluralities of separated nozzles. The material used for the three-dimensional printing is supplied to heads 16 by a building material supply system 42. Tray 12 can have a shape of a disk or it can be annular. Non-round shapes are also contemplated, provided they can be rotated about a vertical axis.

Tray 12 and heads 16 are optionally and preferably mounted such as to allow a relative rotary motion between tray 12 and heads 16. This can be achieved by (i) configuring tray 12 to rotate about a vertical axis 14 relative to heads 16, (ii) configuring heads 16 to rotate about vertical axis 14 relative to tray 12, or (iii) configuring both tray 12 and heads 16 to rotate about vertical axis 14 but at different rotation velocities (e.g., rotation at opposite direction). While some embodiments of system 10 are described below with a particular emphasis to configuration (i) wherein the tray is a rotary tray that is configured to rotate about vertical axis 14 relative to heads 16, it is to be understood that the present application contemplates also configurations (ii) and (iii) for system 10. Any one of the embodiments of system 10 described herein can be adjusted to be applicable to any of configurations (ii) and (iii), and one of ordinary skills in the art, provided with the details described herein, would know how to make such adjustment.

In the following description, a direction parallel to tray 12 and pointing outwardly from axis 14 is referred to as the radial direction r, a direction parallel to tray 12 and perpendicular to the radial direction r is referred to herein as the azimuthal direction φ, and a direction perpendicular to tray 12 is referred to herein is the vertical direction z.

The term “radial position,” as used herein, refers to a position on or above tray 12 at a specific distance from axis 14. When the term is used in connection to a printing head, the term refers to a position of the head which is at specific distance from axis 14. When the term is used in connection to a point on tray 12, the term corresponds to any point that belongs to a locus of points that is a circle whose radius is the specific distance from axis 14 and whose center is at axis 14.

The term “azimuthal position,” as used herein, refers to a position on or above tray 12 at a specific azimuthal angle relative to a predetermined reference point. Thus, radial position refers to any point that belongs to a locus of points that is a straight line forming the specific azimuthal angle relative to the reference point.

The term “vertical position,” as used herein, refers to a position over a plane that intersect the vertical axis 14 at a specific point.

Tray 12 serves as a building platform for three-dimensional printing. The working area on which one or objects are printed is typically, but not necessarily, smaller than the total area of tray 12. In some embodiments of the present invention the working area is annular. The working area is shown at 26. In some embodiments of the present invention tray 12 rotates continuously in the same direction throughout the formation of object, and in some embodiments of the present invention tray reverses the direction of rotation at least once (e.g., in an oscillatory manner) during the formation of the object. Tray 12 is optionally and preferably removable. Removing tray 12 can be for maintenance of system 10, or, if desired, for replacing the tray before printing a new object. In some embodiments of the present invention system 10 is provided with one or more different replacement trays (e.g., a kit of replacement trays), wherein two or more trays are designated for different types of objects (e.g., different weights) different operation modes (e.g., different rotation speeds), etc. The replacement of tray 12 can be manual or automatic, as desired. When automatic replacement is employed, system 10 comprises a tray replacement device 36 configured for removing tray 12 from its position below heads 16 and replacing it by a replacement tray (not shown). In the representative illustration of FIG. 1B tray replacement device 36 is illustrated as a drive 38 with a movable arm 40 configured to pull tray 12, but other types of tray replacement devices are also contemplated.

Exemplified embodiments for the printing head 16 are illustrated in FIGS. 2A-2C. These embodiments can be employed for any of the AM systems described above, including, without limitation, system 110 and system 10.

FIGS. 2A-B illustrate a printing head 16 with one (FIG. 2A) and two (FIG. 2B) nozzle arrays 22. The nozzles in the array are preferably aligned linearly, along a straight line. In embodiments in which a particular printing head has two or more linear nozzle arrays, the nozzle arrays are optionally and preferably can be parallel to each other. When a printing head has two or more arrays of nozzles (e.g., FIG. 2B) all arrays of the head can be fed with the same building material formulation, or at least two arrays of the same head can be fed with different building material formulations.

When a system similar to system 110 is employed, all printing heads 16 are optionally and preferably oriented along the indexing direction with their positions along the scanning direction being offset to one another.

When a system similar to system 10 is employed, all printing heads 16 are optionally and preferably oriented radially (parallel to the radial direction) with their azimuthal positions being offset to one another. Thus, in these embodiments, the nozzle arrays of different printing heads are not parallel to each other but are rather at an angle to each other, which angle being approximately equal to the azimuthal offset between the respective heads. For example, one head can be oriented radially and positioned at azimuthal position φ₁, and another head can be oriented radially and positioned at azimuthal position φ₂. In this example, the azimuthal offset between the two heads is φ₁-φ₂, and the angle between the linear nozzle arrays of the two heads is also φ₁-φ₂.

In some embodiments, two or more printing heads can be assembled to a block of printing heads, in which case the printing heads of the block are typically parallel to each other. A block including several inkjet printing heads 16a, 16b, 16c is illustrated in FIG. 2C.

In some embodiments, system 10 comprises a stabilizing structure 30 positioned below heads 16 such that tray 12 is between stabilizing structure 30 and heads 16. Stabilizing structure 30 may serve for preventing or reducing vibrations of tray 12 that may occur while inkjet printing heads 16 operate. In configurations in which printing heads 16 rotate about axis 14, stabilizing structure 30 preferably also rotates such that stabilizing structure 30 is always directly below heads 16 (with tray 12 between heads 16 and tray 12).

Tray 12 and/or printing heads 16 is optionally and preferably configured to move along the vertical direction z, parallel to vertical axis 14 so as to vary the vertical distance between tray 12 and printing heads 16. In configurations in which the vertical distance is varied by moving tray 12 along the vertical direction, stabilizing structure 30 preferably also moves vertically together with tray 12. In configurations in which the vertical distance is varied by heads 16 along the vertical direction, while maintaining the vertical position of tray 12 fixed, stabilizing structure 30 is also maintained at a fixed vertical position.

The vertical motion can be established by a vertical drive 28. Once a layer is completed, the vertical distance between tray 12 and heads 16 can be increased (e.g., tray 12 is lowered relative to heads 16) by a predetermined vertical step, according to the desired thickness of the layer subsequently to be printed. The procedure is repeated to form a three-dimensional object in a layer-wise manner.

The operation of inkjet printing heads 16 and optionally and preferably also of one or more other components of system 10, e.g., the motion of tray 12, are controlled by a controller 20. The controller can have an electronic circuit and a non-volatile memory medium readable by the circuit, wherein the memory medium stores program instructions which, when read by the circuit, cause the circuit to perform control operations as further detailed below.

Controller 20 can also communicate with a host computer 24 which transmits digital data pertaining to fabrication instructions based on computer object data, e.g., in a form of a Standard Tessellation Language (STL) or a StereoLithography Contour (SLC) format, Virtual Reality Modeling Language (VRML), Additive Manufacturing File (AMF) format, Drawing Exchange Format (DXF), Polygon File Format (PLY), 3D Manufacturing Format (3MF), Object file format (OBJ), or any other format suitable for Computer-Aided Design (CAD). The object data formats are typically structured according to a Cartesian system of coordinates. In these cases, computer 24 preferably executes a procedure for transforming the coordinates of each slice in the computer object data from a Cartesian system of coordinates into a polar system of coordinates. Computer 24 optionally and preferably transmits the fabrication instructions in terms of the transformed system of coordinates. Alternatively, computer 24 can transmit the fabrication instructions in terms of the original system of coordinates as provided by the computer object data, in which case the transformation of coordinates is executed by the circuit of controller 20.

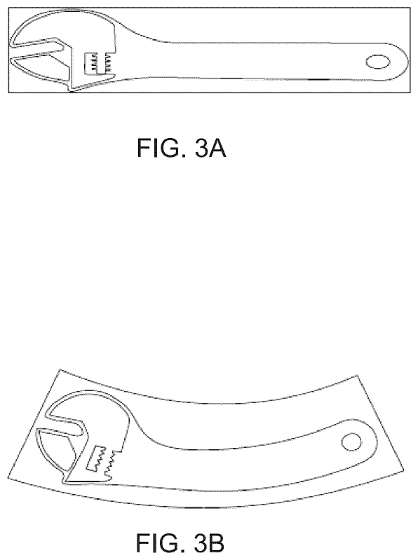

The transformation of coordinates allows three-dimensional printing over a rotating tray. In non-rotary systems with a stationary tray with the printing heads typically reciprocally move above the stationary tray along straight lines. In such systems, the printing resolution is the same at any point over the tray, provided the dispensing rates of the heads are uniform. In system 10, unlike non-rotary systems, not all the nozzles of the head points cover the same distance over tray 12 during at the same time. The transformation of coordinates is optionally and preferably executed so as to ensure equal amounts of excess material formulation at different radial positions. Representative examples of coordinate transformations according to some embodiments of the present invention are provided in FIGS. 3A-B, showing three slices of an object (each slice corresponds to fabrication instructions of a different layer of the objects), where FIG. 3A illustrates a slice in a Cartesian system of coordinates and FIG. 3B illustrates the same slice following an application of a transformation of coordinates procedure to the respective slice.

Typically, controller 20 controls the voltage applied to the respective component of the system 10 based on the fabrication instructions and based on the stored program instructions as described below.

Generally, controller 20 controls printing heads 16 to dispense, during the rotation of tray 12, droplets of building material formulation in layers, such as to print a three-dimensional object on tray 12.

System 10 optionally and preferably comprises one or more radiation sources 18, which can be, for example, an ultraviolet or visible or infrared lamp, or other sources of electromagnetic radiation, or electron beam source, depending on the modeling material formulation being used. Radiation source can include any type of radiation emitting device, including, without limitation, light emitting diode (LED), digital light processing (DLP) system, resistive lamp and the like. Radiation source 18 serves for curing or solidifying the modeling material formulation. In various exemplary embodiments of the invention the operation of radiation source 18 is controlled by controller 20 which may activate and deactivate radiation source 18 and may optionally also control the amount of radiation generated by radiation source 18.

In some embodiments of the invention, system 10 further comprises one or more leveling devices 32 which can be manufactured as a roller or a blade. Leveling device 32 serves to straighten the newly formed layer prior to the formation of the successive layer thereon. In some embodiments, leveling device 32 has the shape of a conical roller positioned such that its symmetry axis 34 is tilted relative to the surface of tray 12 and its surface is parallel to the surface of the tray. This embodiment is illustrated in the side view of system 10 (FIG. 1C).

The conical roller can have the shape of a cone or a conical frustum.

The opening angle of the conical roller is preferably selected such that there is a constant ratio between the radius of the cone at any location along its axis 34 and the distance between that location and axis 14. This embodiment allows roller 32 to efficiently level the layers, since while the roller rotates, any point p on the surface of the roller has a linear velocity which is proportional (e.g., the same) to the linear velocity of the tray at a point vertically beneath point p. In some embodiments, the roller has a shape of a conical frustum having a height h, a radius R₁ at its closest distance from axis 14, and a radius R₂ at its farthest distance from axis 14, wherein the parameters h, R₁ and R₂ satisfy the relation R₁/R₂=(R−h)/h and wherein R is the farthest distance of the roller from axis 14 (for example, R can be the radius of tray 12).

The operation of leveling device 32 is optionally and preferably controlled by controller 20 which may activate and deactivate leveling device 32 and may optionally also control its position along a vertical direction (parallel to axis 14) and/or a radial direction (parallel to tray 12 and pointing toward or away from axis 14.

In some embodiments of the present invention printing heads 16 are configured to reciprocally move relative to tray along the radial direction r. These embodiments are useful when the lengths of the nozzle arrays 22 of heads 16 are shorter than the width along the radial direction of the working area 26 on tray 12. The motion of heads 16 along the radial direction is optionally and preferably controlled by controller 20.

Some embodiments contemplate the fabrication of an object by dispensing different material formulations from different arrays of nozzles (belonging to the same or different printing head). These embodiments provide, inter alia, the ability to select material formulations from a given number of material formulations and define desired combinations of the selected material formulations and their properties. According to the present embodiments, the spatial locations of the deposition of each material formulation with the layer is defined, either to effect occupation of different three-dimensional spatial locations by different material formulations, or to effect occupation of substantially the same three-dimensional location or adjacent three-dimensional locations by two or more different material formulations so as to allow post deposition spatial combination of the material formulations within the layer, thereby to form a composite material formulation at the respective location or locations.

Any post deposition combination or mix of modeling material formulations is contemplated. For example, once a certain material formulation is dispensed it may preserve its original properties. However, when it is dispensed simultaneously with another modeling material formulation or other dispensed material formulations which are dispensed at the same or nearby locations, a composite material formulation having a different property or properties to the dispensed material formulations may be formed.

In some embodiments of the present invention the system dispenses digital material formulation for at least one of the layers.

The phrase “digital material formulations”, as used herein and in the art, describes a combination of two or more material formulations on a pixel level or voxel level such that pixels or voxels of different material formulations are interlaced with one another over a region. Such digital material formulations may exhibit new properties that are affected by the selection of types of material formulations and/or the ratio and relative spatial distribution of two or more material formulations.

As used herein, a “voxel” of a layer refers to a physical three-dimensional elementary volume within the layer that corresponds to a single pixel of a bitmap describing the layer. The size of a voxel is approximately the size of a region that is formed by a building material, once the building material is dispensed at a location corresponding to the respective pixel, leveled, and solidified.

The present embodiments thus enable the deposition of a broad range of material formulation combinations, and the fabrication of an object which may consist of multiple different combinations of material formulations, in different parts of the object, according to the properties desired to characterize each part of the object.

Further details on the principles and operations of an AM system suitable for the present embodiments are found in U.S. Pat. No. 9,031,680, and International Publication No. WO 2016/009426, the contents of which are hereby incorporated by reference.

It is to be noted that while the description herein focuses on 3D-inkjet printing, the curable formulation as described herein, and the additive manufacturing process employing same can be utilized in 3D printing methodologies in which the curable formulation is stored in a vat, which methodologies are also known as VAT polymerization and typically include Stereolithography (SLA) and Digital Light Processing (DLP) methodologies.

SLA and DLP are additive manufacturing technologies in which an uncured building material in a bath is converted into hardened material(s), layer by layer, by selective curing using a light source while the uncured material is later separated/washed from the hardened material.

SLA is widely used to create models, prototypes, patterns, and production parts for a range of industries including for Bioprinting. DLP differs from laser-based SLA is that DLP uses a projection of ultraviolet (UV) light (or visible light) from a digital projector to flash a single image of the layer across the entire uncured material at once. One of the key components of DLP is a digital micromirror device (DMD) chip, which is typically composed of an array of reflective aluminum micromirrors that redirect incoming light from the UV source to project an image of a designed pattern. For achieving a high-resolution structure, parameters such as the curing time of each layer, layer thickness, and intensity of the UV light should be tuned, for example, by controlling the concentration and types of the curable materials and the photoinitiator.

As used herein the term “about” refers to ±10% or ±5%.

The terms “comprises”, “comprising”, “includes”, “including”, “having” and their conjugates mean “including but not limited to”.

The term “consisting of” means “including and limited to”.

The term “consisting essentially of” means that the composition, method or structure may include additional ingredients, steps and/or parts, but only if the additional ingredients, steps and/or parts do not materially alter the basic and novel characteristics of the claimed composition, method or structure.

As used herein, the singular form “a”, “an” and “the” include plural references unless the context clearly dictates otherwise. For example, the term “a compound” or “at least one compound” may include a plurality of compounds, including mixtures thereof.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

As used herein the term “method”, which is also referred to herein interchangeably as “process”, refers to manners, means, techniques and procedures for accomplishing a given task including, but not limited to, those manners, means, techniques and procedures either known to, or readily developed from known manners, means, techniques and procedures by practitioners of the chemical, engineering, physical and mechanical arts.

Herein throughout, whenever the phrase “weight percent”, or “% by weight” or “% wt.”, is indicated in the context of embodiments of a formulation (e.g., a modeling formulation), it is meant weight percent of the total weight of the respective uncured formulation.

Herein throughout, an acrylic material is used to collectively describe material featuring one or more acrylate, methacrylate, acrylamide and/or methacrylamide group(s).

Similarly, an acrylic group is used to collectively describe curable groups which are acrylate, methacrylate, acrylamide and/or methacrylamide group(s), preferably acrylate or methacrylate groups (referred to herein also as (meth)acrylate groups).

Herein throughout, the term “(meth)acrylic” encompasses acrylic and methacrylic materials.

Herein throughout, the phrase “linking moiety” or “linking group” describes a group that connects two or more moieties or groups in a compound. A linking moiety is typically derived from a bi- or tri-functional compound, and can be regarded as a bi- or tri-radical moiety, which is connected to two or three other moieties, via two or three atoms thereof, respectively.

Exemplary linking moieties include a hydrocarbon moiety or chain, optionally interrupted by one or more heteroatoms, as defined herein, and/or any of the chemical groups listed below, when defined as linking groups.

When a chemical group is referred to herein as “end group” it is to be interpreted as a substituent, which is connected to another group via one atom thereof.

Herein throughout, the term “hydrocarbon” collectively describes a chemical group composed mainly of carbon and hydrogen atoms. A hydrocarbon can be comprised of alkyl, alkene, alkyne, aryl, and/or cycloalkyl, each can be substituted or unsubstituted, and can be interrupted by one or more heteroatoms. The number of carbon atoms can range from 2 to 30, and is preferably lower, e.g., from 1 to 10, or from 1 to 6, or from 1 to 4. A hydrocarbon can be a linking group or an end group.

Bisphenol A is an example of a hydrocarbon comprised of 2 aryl groups and one alkyl group. Dimethylenecyclohexane is an example of a hydrocarbon comprised of 2 alkyl groups and one cycloalkyl group.

As used herein, the term “amine” describes both a —NR′R″ group and a —NR′— group, wherein R′ and R″ are each independently hydrogen, alkyl, cycloalkyl, aryl, as these terms are defined hereinbelow.

The amine group can therefore be a primary amine, where both R′ and R″ are hydrogen, a secondary amine, where R′ is hydrogen and R″ is alkyl, cycloalkyl or aryl, or a tertiary amine, where each of R′ and R″ is independently alkyl, cycloalkyl or aryl.

Alternatively, R′ and R″ can each independently be hydroxyalkyl, trihaloalkyl, cycloalkyl, alkenyl, alkynyl, aryl, heteroaryl, heteroalicyclic, amine, halide, sulfonate, sulfoxide, phosphonate, hydroxy, alkoxy, aryloxy, thiohydroxy, thioalkoxy, thioaryloxy, cyano, nitro, azo, sulfonamide, carbonyl, C-carboxylate, O-carboxylate, N-thiocarbamate, O-thiocarbamate, urea, thiourea, N-carbamate, O-carbamate, C-amide, N-amide, guanyl, guanidine and hydrazine.

The term “amine” is used herein to describe a —NR′R″ group in cases where the amine is an end group, as defined hereinunder, and is used herein to describe a —NR′— group in cases where the amine is a linking group or is or part of a linking moiety.

The term “alkyl” describes a saturated aliphatic hydrocarbon including straight chain and branched chain groups. Preferably, the alkyl group has 1 to 30, or 1 to 20 carbon atoms. Whenever a numerical range; e.g., “1-20”, is stated herein, it implies that the group, in this case the alkyl group, may contain 1 carbon atom, 2 carbon atoms, 3 carbon atoms, etc., up to and including 20 carbon atoms. The alkyl group may be substituted or unsubstituted. Substituted alkyl may have one or more substituents, whereby each substituent group can independently be, for example, hydroxyalkyl, trihaloalkyl, cycloalkyl, alkenyl, alkynyl, aryl, heteroaryl, heteroalicyclic, amine, halide, sulfonate, sulfoxide, phosphonate, hydroxy, alkoxy, aryloxy, thiohydroxy, thioalkoxy, thioaryloxy, cyano, nitro, azo, sulfonamide, C-carboxylate, O-carboxylate, N-thiocarbamate, O-thiocarbamate, urea, thiourea, N-carbamate, O-carbamate, C-amide, N-amide, guanyl, guanidine and hydrazine.

The alkyl group can be an end group, as this phrase is defined hereinabove, wherein it is attached to a single adjacent atom, or a linking group, as this phrase is defined hereinabove, which connects two or more moieties via at least two carbons in its chain. When the alkyl is a linking group, it is also referred to herein as “alkylene” or “alkylene chain”.

Alkene and Alkyne, as used herein, are an alkyl, as defined herein, which contains one or more double bond or triple bond, respectively.

The term “cycloalkyl” describes an all-carbon monocyclic ring or fused rings (i.e., rings which share an adjacent pair of carbon atoms) group where one or more of the rings does not have a completely conjugated pi-electron system. Examples include, without limitation, cyclohexane, adamantine, norbornyl, isobornyl, and the like. The cycloalkyl group may be substituted or unsubstituted. Substituted cycloalkyl may have one or more substituents, whereby each substituent group can independently be, for example, hydroxyalkyl, trihaloalkyl, cycloalkyl, alkenyl, alkynyl, aryl, heteroaryl, heteroalicyclic, amine, halide, sulfonate, sulfoxide, phosphonate, hydroxy, alkoxy, aryloxy, thiohydroxy, thioalkoxy, thioaryloxy, cyano, nitro, azo, sulfonamide, C-carboxylate, O-carboxylate, N-thiocarbamate, O-thiocarbamate, urea, thiourea, N-carbamate, O-carbamate, C-amide, N-amide, guanyl, guanidine and hydrazine. The cycloalkyl group can be an end group, as this phrase is defined hereinabove, wherein it is attached to a single adjacent atom, or a linking group, as this phrase is defined hereinabove, connecting two or more moieties at two or more positions thereof.

The term “heteroalicyclic” describes a monocyclic or fused ring group having in the ring(s) one or more atoms such as nitrogen, oxygen and sulfur. The rings may also have one or more double bonds. However, the rings do not have a completely conjugated pi-electron system. Representative examples are piperidine, piperazine, tetrahydrofurane, tetrahydropyrane, morpholino, oxalidine, and the like.

The heteroalicyclic may be substituted or unsubstituted. Substituted heteroalicyclic may have one or more substituents, whereby each substituent group can independently be, for example, hydroxyalkyl, trihaloalkyl, cycloalkyl, alkenyl, alkynyl, aryl, heteroaryl, heteroalicyclic, amine, halide, sulfonate, sulfoxide, phosphonate, hydroxy, alkoxy, aryloxy, thiohydroxy, thioalkoxy, thioaryloxy, cyano, nitro, azo, sulfonamide, C-carboxylate, O-carboxylate, N-thiocarbamate, O-thiocarbamate, urea, thiourea, O-carbamate, N-carbamate, C-amide, N-amide, guanyl, guanidine and hydrazine. The heteroalicyclic group can be an end group, as this phrase is defined hereinabove, where it is attached to a single adjacent atom, or a linking group, as this phrase is defined hereinabove, connecting two or more moieties at two or more positions thereof.

The term “aryl” describes an all-carbon monocyclic or fused-ring polycyclic (i.e., rings which share adjacent pairs of carbon atoms) groups having a completely conjugated pi-electron system. The aryl group may be substituted or unsubstituted. Substituted aryl may have one or more substituents, whereby each substituent group can independently be, for example, hydroxyalkyl, trihaloalkyl, cycloalkyl, alkenyl, alkynyl, aryl, heteroaryl, heteroalicyclic, amine, halide, sulfonate, sulfoxide, phosphonate, hydroxy, alkoxy, aryloxy, thiohydroxy, thioalkoxy, thioaryloxy, cyano, nitro, azo, sulfonamide, C-carboxylate, O-carboxylate, N-thiocarbamate, O-thiocarbamate, urea, thiourea, N-carbamate, O-carbamate, C-amide, N-amide, guanyl, guanidine and hydrazine. The aryl group can be an end group, as this term is defined hereinabove, wherein it is attached to a single adjacent atom, or a linking group, as this term is defined hereinabove, connecting two or more moieties at two or more positions thereof.

The term “heteroaryl” describes a monocyclic or fused ring (i.e., rings which share an adjacent pair of atoms) group having in the ring(s) one or more atoms, such as, for example, nitrogen, oxygen and sulfur and, in addition, having a completely conjugated pi-electron system. Examples, without limitation, of heteroaryl groups include pyrrole, furan, thiophene, imidazole, oxazole, thiazole, pyrazole, pyridine, pyrimidine, quinoline, isoquinoline and purine. The heteroaryl group may be substituted or unsubstituted. Substituted heteroaryl may have one or more substituents, whereby each substituent group can independently be, for example, hydroxyalkyl, trihaloalkyl, cycloalkyl, alkenyl, alkynyl, aryl, heteroaryl, heteroalicyclic, amine, halide, sulfonate, sulfoxide, phosphonate, hydroxy, alkoxy, aryloxy, thiohydroxy, thioalkoxy, thioaryloxy, cyano, nitro, azo, sulfonamide, C-carboxylate, O-carboxylate, N-thiocarbamate, O-thiocarbamate, urea, thiourea, O-carbamate, N-carbamate, C-amide, N-amide, guanyl, guanidine and hydrazine. The heteroaryl group can be an end group, as this phrase is defined hereinabove, where it is attached to a single adjacent atom, or a linking group, as this phrase is defined hereinabove, connecting two or more moieties at two or more positions thereof. Representative examples are pyridine, pyrrole, oxazole, indole, purine and the like.

The term “halide” and “halo” describes fluorine, chlorine, bromine or iodine.

The term “haloalkyl” describes an alkyl group as defined above, further substituted by one or more halide.

The term “sulfate” describes a —O—S(═O)₂—OR′ end group, as this term is defined hereinabove, or an —O—S(═O)₂—O— linking group, as these phrases are defined hereinabove, where R′ is as defined hereinabove.

The term “thiosulfate” describes a —O—S(═S)(═O)—OR′ end group or a —O—S(═S)(═O)—O— linking group, as these phrases are defined hereinabove, where R′ is as defined hereinabove.

The term “sulfite” describes an —O—S(═O)—O—R′ end group or a —O—S(═O)—O— group linking group, as these phrases are defined hereinabove, where R′ is as defined hereinabove.

The term “thiosulfite” describes a —O—S(═S)—O—R′ end group or an —O—S(═S)—O— group linking group, as these phrases are defined hereinabove, where R′ is as defined hereinabove.

The term “sulfinate” describes a —S(═O)—OR′ end group or an —S(═O)—O— group linking group, as these phrases are defined hereinabove, where R′ is as defined hereinabove.

The term “sulfoxide” or “sulfinyl” describes a —S(═O)R′ end group or an —S(═O)— linking group, as these phrases are defined hereinabove, where R′ is as defined hereinabove.

The term “sulfonate” describes a —S(═O)₂—R′ end group or an —S(═O)₂— linking group, as these phrases are defined hereinabove, where R′ is as defined herein.

The term “S-sulfonamide” describes a —S(═O)₂—NR′R″ end group or a —S(═O)₂—NR′— linking group, as these phrases are defined hereinabove, with R′ and R″ as defined herein.

The term “N-sulfonamide” describes an R′S(═O)₂—NR″— end group or a —S(═O)₂—NR′— linking group, as these phrases are defined hereinabove, where R′ and R″ are as defined herein.

The term “disulfide” refers to a —S—SR′ end group or a —S—S— linking group, as these phrases are defined hereinabove, where R′ is as defined herein.

The term “phosphonate” describes a —P(═O)(OR′)(OR″) end group or a —P(═O)(OR′)(O)— linking group, as these phrases are defined hereinabove, with R′ and R″ as defined herein.

The term “thiophosphonate” describes a —P(═S)(OR′)(OR″) end group or a —P(═S)(OR′)(O)— linking group, as these phrases are defined hereinabove, with R′ and R″ as defined herein.

The term “phosphinyl” describes a —PR′R″ end group or a —PR′— linking group, as these phrases are defined hereinabove, with R′ and R″ as defined hereinabove.

The term “phosphine oxide” describes a —P(═O)(R′)(R″) end group or a —P(═O)(R′)— linking group, as these phrases are defined hereinabove, with R′ and R″ as defined herein.

The term “phosphine sulfide” describes a —P(═S)(R′)(R″) end group or a —P(═S)(R′)— linking group, as these phrases are defined hereinabove, with R′ and R″ as defined herein.

The term “phosphite” describes an —O—PR′(═O)(OR″) end group or an —O—PH(═O)(O)— linking group, as these phrases are defined hereinabove, with R′ and R″ as defined herein.

The term “carbonyl” or “carbonate” as used herein, describes a —C(═O)—R′ end group or a —C(═O)— linking group, as these phrases are defined hereinabove, with R′ as defined herein.

The term “thiocarbonyl” as used herein, describes a —C(═S)—R′ end group or a —C(═S)-linking group, as these phrases are defined hereinabove, with R′ as defined herein.

The term “oxo” as used herein, describes a (═O) group, wherein an oxygen atom is linked by a double bond to the atom (e.g., carbon atom) at the indicated position.

The term “thiooxo” as used herein, describes a (═S) group, wherein a sulfur atom is linked by a double bond to the atom (e.g., carbon atom) at the indicated position.

The term “oxime” describes a ═N—OH end group or a ═N—O— linking group, as these phrases are defined hereinabove.

The term “hydroxyl” describes a —OH group.

The term “alkoxy” describes both an —O-alkyl and an —O-cycloalkyl group, as defined herein. The term alkoxide describes —R′O— group, with R′ as defined herein.

The term “aryloxy” describes both an —O-aryl and an —O-heteroaryl group, as defined herein.

The term “thiohydroxy” or “thiol” describes a —SH group. The term “thiolate” describes a —S— group.

The term “thioalkoxy” describes both a —S-alkyl group, and a —S-cycloalkyl group, as defined herein.

The term “thioaryloxy” describes both a —S-aryl and a —S-heteroaryl group, as defined herein.

The “hydroxyalkyl” is also referred to herein as “alcohol”, and describes an alkyl, as defined herein, substituted by a hydroxy group.

The term “cyano” describes a —C≡N group.

The term “isocyanate” describes an —N═C═O group.

The term “isothiocyanate” describes an —N═C═S group.

The term “nitro” describes an —NO₂ group.

The term “acyl halide” describes a —(C═O)R″″ group wherein R″″ is halide, as defined hereinabove.

The term “azo” or “diazo” describes an —N═NR′ end group or an —N═N— linking group, as these phrases are defined hereinabove, with R′ as defined hereinabove.

The term “peroxo” describes an —O—OR′ end group or an —O—O— linking group, as these phrases are defined hereinabove, with R′ as defined hereinabove.

The term “carboxylate” as used herein encompasses C-carboxylate and O-carboxylate.

The term “C-carboxylate” describes a —C(═O)—OR′ end group or a —C(═O)—O— linking group, as these phrases are defined hereinabove, where R′ is as defined herein.

The term “O-carboxylate” describes a —OC(═O)R′ end group or a —OC(═O)— linking group, as these phrases are defined hereinabove, where R′ is as defined herein.

A carboxylate can be linear or cyclic. When cyclic, R′ and the carbon atom are linked together to form a ring, in C-carboxylate, and this group is also referred to as lactone. Alternatively, R′ and O are linked together to form a ring in O-carboxylate. Cyclic carboxylates can function as a linking group, for example, when an atom in the formed ring is linked to another group.

The term “thiocarboxylate” as used herein encompasses C-thiocarboxylate and O-thiocarboxylate.

The term “C-thiocarboxylate” describes a —C(═S)—OR′ end group or a —C(═S)—O— linking group, as these phrases are defined hereinabove, where R′ is as defined herein.

The term “O-thiocarboxylate” describes a —OC(═S)R′ end group or a —OC(═S)— linking group, as these phrases are defined hereinabove, where R′ is as defined herein.

A thiocarboxylate can be linear or cyclic. When cyclic, R′ and the carbon atom are linked together to form a ring, in C-thiocarboxylate, and this group is also referred to as thiolactone.

Alternatively, R′ and O are linked together to form a ring in O-thiocarboxylate. Cyclic thiocarboxylates can function as a linking group, for example, when an atom in the formed ring is linked to another group.

The term “carbamate” as used herein encompasses N-carbamate and O-carbamate.

The term “N-carbamate” describes an R″OC(═O)—NR′— end group or a —OC(═O)—NR′— linking group, as these phrases are defined hereinabove, with R′ and R″ as defined herein.

The term “O-carbamate” describes an —OC(═O)—NR′R″ end group or an —OC(═O)—NR′— linking group, as these phrases are defined hereinabove, with R′ and R″ as defined herein.

A carbamate can be linear or cyclic. When cyclic, R′ and the carbon atom are linked together to form a ring, in O-carbamate. Alternatively, R′ and O are linked together to form a ring in N-carbamate. Cyclic carbamates can function as a linking group, for example, when an atom in the formed ring is linked to another group.

The term “carbamate” as used herein encompasses N-carbamate and O-carbamate.

The term “thiocarbamate” as used herein encompasses N-thiocarbamate and O-thiocarbamate.

The term “O-thiocarbamate” describes a —OC(═S)—NR′R″ end group or a —OC(═S)—NR′— linking group, as these phrases are defined hereinabove, with R′ and R″ as defined herein.

The term “N-thiocarbamate” describes an R″OC(═S)NR′— end group or a —OC(═S)NR′— linking group, as these phrases are defined hereinabove, with R′ and R″ as defined herein.

Thiocarbamates can be linear or cyclic, as described herein for carbamates.

The term “dithiocarbamate” as used herein encompasses S-dithiocarbamate and N-dithiocarbamate.

The term “S-dithiocarbamate” describes a —SC(═S)—NR′R″ end group or a —SC(═S)NR′— linking group, as these phrases are defined hereinabove, with R′ and R″ as defined herein.

The term “N-dithiocarbamate” describes an R″SC(═S)NR′— end group or a —SC(═S)NR′— linking group, as these phrases are defined hereinabove, with R′ and R″ as defined herein.

The term “urea”, which is also referred to herein as “ureido”, describes a —NR′C(═O)—NR″R″′ end group or a —NR′C(═O)—NR″— linking group, as these phrases are defined hereinabove, where R′ and R″ are as defined herein and R″′ is as defined herein for R′ and R″.

The term “thiourea”, which is also referred to herein as “thioureido”, describes a —NR′—C(═S)—NR″R″′ end group or a —NR′—C(═S)—NR″— linking group, with R′, R″ and R″′ as defined herein.

The term “amide” as used herein encompasses C-amide and N-amide.

The term “C-amide” describes a —C(═O)—NR′R″ end group or a —C(═O)—NR′— linking group, as these phrases are defined hereinabove, where R′ and R″ are as defined herein.

The term “N-amide” describes a R′C(═O)—NR″— end group or a R′C(═O)—N— linking group, as these phrases are defined hereinabove, where R′ and R″ are as defined herein.

An amide can be linear or cyclic. When cyclic, R′ and the carbon atom are linked together to form a ring, in C-amide, and this group is also referred to as lactam. Cyclic amides can function as a linking group, for example, when an atom in the formed ring is linked to another group.

The term “guanyl” describes a R′R″NC(═N)— end group or a —R′NC(═N)— linking group, as these phrases are defined hereinabove, where R′ and R″ are as defined herein.

The term “guanidine” describes a —R′NC(═N)—NR″R″′ end group or a —R′NC(═N)— NR″— linking group, as these phrases are defined hereinabove, where R′, R″ and R″′ are as defined herein.

The term “hydrazine” describes a —NR′—NR″R″′ end group or a —NR′—NR″— linking group, as these phrases are defined hereinabove, with R′, R″, and R″′ as defined herein.

As used herein, the term “hydrazide” describes a —C(═O)—NR′—NR″R″′ end group or a —C(═O)—NR′—NR″— linking group, as these phrases are defined hereinabove, where R′, R″ and R″′ are as defined herein.

As used herein, the term “thiohydrazide” describes a —C(═S)—NR′—NR″R″′ end group or a —C(═S)—NR′—NR″— linking group, as these phrases are defined hereinabove, where R′, R″ and R″′ are as defined herein.

The term “cyanurate” describes a

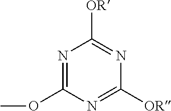

end group or

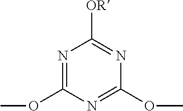

linking group, with R′ and R″ as defined herein.

The term “isocyanurate” describes a

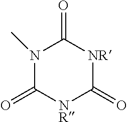

end group or a

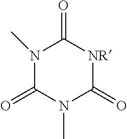

linking group, with R′ and R″ as defined herein.

The term “thiocyanurate” describes a

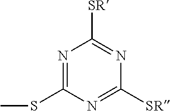

end group or

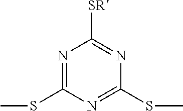

linking group, with R′ and R″ as defined herein.

As used herein, the term “alkylene glycol” describes a —O—[(CR′R″)_{z}—O]_{y}—R″′ end group or a —O—[(CR′R″)_{z}—O]_{y}— linking group, with R′, R″ and R″′ being as defined herein, and with z being an integer of from 1 to 10, preferably, from 2 to 6, more preferably 2 or 3, and y being an integer of 1 or more. Preferably R′ and R″ are both hydrogen. When z is 2 and y is 1, this group is ethylene glycol. When z is 3 and y is 1, this group is propylene glycol. When y is 2-4, the alkylene glycol is referred to herein as oligo(alkylene glycol).

Herein, an “ethoxylated” material describes an acrylic or methacrylic compound which comprises one or more alkylene glycol groups, or, preferably, one or more alkylene glycol chains, as defined herein. Ethoxylated (meth)acrylate materials can be mono-functional, or, preferably, multifunctional, namely, di-functional, tri-functional, tetra-functional, etc.

In multifunctional materials, typically, each of the (meth)acrylate groups are linked to an alkylene glycol group or chain, and the alkylene glycol groups or chains are linked to one another through a branching unit, such as, for example, a branched alkyl, cycloalkyl, aryl (e.g., Bisphenol A), etc.

In some embodiments, the ethoxylated material comprises at least one, or at least two ethoxylated group(s)s, that is, at least one or at least two alkylene glycol moieties or groups. Some or all of the alkylene glycol groups can be linked to one another to form an alkylene glycol chain. For example, an ethoxylated material that comprises 30 ethoxylated groups can comprise a chain of 30 alkylene glycol groups linked to one another, two chains, each, for example, of 15 alkylene glycol moieties linked to one another, the two chains linked to one another via a branching moiety, or three chains, each, for example, of 10 alkylene glycol groups linked to one another, the three chains linked to one another via a branching moiety. Shorter and longer chains are also contemplated.

The ethoxylated material can comprise one, two or more alkylene glycol chains, of any length.

The term “branching unit” as used herein describes a multi-radical, preferably aliphatic or alicyclic group. By “multi-radical” it is meant that the unit has two or more attachment points such that it links between two or more atoms and/or groups or moieties.

In some embodiments, the branching unit is derived from a chemical moiety that has two, three or more functional groups. In some embodiments, the branching unit is a branched alkyl or a cycloalkyl (alicyclic) or an aryl (e.g., phenyl) as defined herein.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination or as suitable in any other described embodiment of the invention. Certain features described in the context of various embodiments are not to be considered essential features of those embodiments, unless the embodiment is inoperative without those elements.

Various embodiments and aspects of the present invention as delineated hereinabove and as claimed in the claims section below find experimental support in the following examples.

### EXAMPLES

Reference is now made to the following examples, which together with the above descriptions illustrate some embodiments of the invention in a non-limiting fashion.

### EXPERIMENTAL METHODS

Shore A Hardness was determined in accordance with ASTM D2240.

Tensile Strength was determined in accordance with ASTM D412 and is expressed in MPa units.

Elongation at break was determined in accordance with ASTM D412 and is expressed as Tear Resistance (TR) was determined in accordance with ASTM D 624 and is expressed by Kg/cm units.

Resilience (energy dissipating efficiency; EDE) was determining in accordance to the procedure described in Zhao et al., Molecules 2020, 25, 597, based on cyclic strain-strain curves, according to the following equation:

$$E D E ( \% ) = \frac{Area Return}{Area Extension} \times 100$$

Viscosity is measured using a Brookfield viscometer, and is presented as Brookfield viscosity in centipoises units, which correspond to mPa/second.

Surface tension is measured using Kruss K6 Force Tensiometer, and is presented in Dyne/cm units.

Formulations were prepared by mixing all components at room temperature unless otherwise indicated. Powder components such as photoinitiators were dissolved at 85° C. for 30 minutes.

### Example 1

### Design

The present inventors have previously uncovered that introducing silica particles, preferably silica particles that are functionalized by curable groups, to elastomeric formulations usable in additive manufacturing such as 3D inkjet printing provides for improved properties of the obtained hardened rubber-like material. Such formulations are described, for example, in WO 2017/208238 and are marketed under the trade name Agilus30™.

While such formulations indeed provide for hardened materials that feature high elongation along with relatively high tear resistance, the present inventors have uncovered that, presumably due the hydrophilic nature of the curable materials in these formulations and consequent water absorption, a deterioration in the mechanical properties of objects made of such formulations may be observed under certain conditions.

In a search for formulations that provide, when hardened, rubber-like materials with improved mechanical properties (e.g., maintaining mechanical properties over time), the present inventors have conceived using curable materials that provide, when hardened, rubber-like materials, optionally transparent, and which are more hydrophobic.

The present inventors have tested ample formulations that comprise various multi-functional hydrophobic, elastomeric, curable materials, in combination with various mono-functional hydrophobic curable materials, at varying proportions, as shown in Tables 1 and 2 below. Upon determining the mechanical properties of the hardened materials formed thereby, as shown in Tables 3 and 4 below, the present inventors have identified the components and relative amounts thereof that are required for making up formulations that provide, when hardened, elastomeric materials with improved mechanical properties, and which maintain these properties over time.

Table 1 below presents the various materials used in the tested formulations.

TABLE 1

| | |
|---|---|
| Component A | Mono-functional hydrophobic (meth)acrylate |
| | featuring Low Tg (e.g., lower than 0, or |
| | from −80 to 0, ° C.) |
| Component B | Mono-functional hydrophobic (e.g., alicyclic) |
| | (meth)acrylate featuring Medium Tg (e.g., |
| | 0-100, or 20-80, or 20-60, ° C.) |
| Component B1 | Mono-functional hydrophobic ((e.g., alicyclic) |
| | (meth)acrylate featuring Medium Tg and |
| | viscosity higher than 10 centipoises |
| | (mPa · second), e.g., of from 10 to 24 centipoises |
| Component B2 | Mono-functional hydrophobic ((e.g., alicyclic) |
| | (meth)acrylate featuring Medium Tg and |
| | viscosity lower than 10, or lower than 5, |
| | centipoises (mPa · second), e.g., of |
| | from 1 to 8 centipoises |
| Component C | Mono-functional hydrophilic (meth)acrylate |
| | featuring Low Tg (e.g., lower than 0, or |
| | from −80 to 0, ° C.) |
| Component D | Multi-functional (e.g., di-functional or tri- |
| | functional) (e.g., ethoxylated) (meth)acrylate |
| | featuring Medium to high Tg (e.g., of 50 to 150, |
| | or of 80-150, or about 100° C.) |
| Component E | Multi-functional (e.g., di-functional) |
| | hydrophobic elastomer |
| Component E1 | Multi-functional (e.g., di-functional) |
| | polybutadiene urethane (meth)acrylate |
| Component E2 | Multi-functional (e.g., di-functional) urethane |
| | (meth)acrylate |
| Component F | Silicone-containing material |
| Component F1 | Silicone (meth)acrylate (e.g., di-functional) |
| | (e.g., silicone di(meth)acrylate; silicone |
| | polyester di(meth)acrylate) |
| Component F2 | Non-curable silicone (e.g., polyether siloxane |
| | copolymer) |
| Component H | Dispersant/surface active agent |
| Component I | Polymerization Inhibitor |
| Component J | Photoinitiator |

### Example 2

### Formulations

Table 2 below presents the chemical composition of exemplary tested formulations. Numbers under each component present the concentration of the respective component in the formulation in weight percent.

All formulations included a polymerization inhibitor (Component I) at a concentration of 0.1-1, or 0.5-1% by weight; and a photoinitiator (Component J) at a concentration of 1-3, or 1-2, % by weight. Some formulations included also a dispersant/surface active agent (Component H) at a concentration of 0.01-0.1. Some formulations also included, instead of, or in addition to, Component D as described herein, a compound a curable material that comprises at least two hydrogen bond forming groups (Component MA as described herein in any of the respective embodiments) (e.g., methacrylamide).

TABLE 2

| No. | A | B1 | B2 | C | D | E1 | E2 | F1 | F2 |
|---|---|---|---|---|---|---|---|---|---|
| 1 | 10-20 | 20-30 | 25-35 | X | X | 30-40 | X | X | X |
| | (15) | (25.7) | (30) | | | (35) | | | |
| 2 | 10-20 | 20-30 | 25-35 | X | X | 25-30 | X | X | X |
| | (15) | (25.7) | (30) | | | (27.5) | | | |
| 3 | 10-20 | 20-30 | 25-35 | X | X | 25-30 | X | X | X |
| | (15) | (25.7) | (30) | | | (27.5) | | | |
| 4 | 10-20 | 20-30 | 25-35 | X | X | 25-30 | X | X | X |
| | (15) | (25.7) | (30) | | | (27.5) | | | |
| 5 | 10-20 | 20-30 | 25-35 | X | X | X | 25-30 | X | X |
| | (15) | (25.7) | (30) | | | | (27.5) | | |
| 6 | 10-20 | 20-30 | 25-35 | X | X | X | 25-30 | X | X |
| | (15) | (25.7) | (30) | | | | (27.5) | | |
| 7 | 10-20 | 20-30 | 25-35 | X | X | 25-30 | X | 1-10 | X |
| | (14.3) | (24.5) | (28.6) | | | (26.2) | | (4.8) | |
| 8 | 10-20 | 20-30 | 25-35 | X | 1-5 | 25-30 | X | X | X |
| | (14.7) | (25.2) | (29.4) | | (2) | (27) | | | |
| 9 | 5-15 | 15-25 | 20-30 | X | X | 20-30 | X | 15-25 | X |
| | (10) | (20) | (24) | | | (24.2) | | (20) | |
| 10 | 5-15 | 15-25 | 20-30 | X | 1-5 | 20-25 | X | 15-25 | X |
| | (9.7) | (19.4) | (23.3) | | (2.9) | (3.5) | | (20) | |
| 11 | 10-20 | 20-30 | 25-35 | X | X | 25-30 | X | X | X |
| | (15) | (25) | (30) | | | (28.2) | | | |
| 12 | 10-20 | 25-35 | 30-40 | X | X | 5-15 | X | X | X |
| | (18.8) | (31.3) | (37.6) | | | (10) | | | |
| 13 | 10-20 | 25-35 | 30-40 | X | X | 5-15 | X | 5-15 | X |
| | (16.7) | (27.9) | (33.4) | | | (10) | | (10) | |
| 14 | 10-20 | 20-30 | 25-35 | X | X | 25-30 | X | X | X |
| | (15) | (25) | (30) | | | (28.2) | | | |
| 15 | X | 20-30 | 25-35 | 10-20 | X | 25-30 | X | X | X |
| | | (25) | (30) | (15) | | (28.2) | | | |
| 16 | X | 20-30 | 25-35 | 10-20 | X | 25-30 | X | X | X |
| | | (25) | (30) | (15) | | (28.2) | | | |
| 17 | X | 20-30 | 25-35 | 10-20 | X | 25-30 | X | X | X |
| | | (25) | (30) | (15) | | (28.2) | | | |
| 18 | 5-15 | 20-30 | 25-35 | 1-10 | X | 25-30 | X | X | X |
| | (10) | (25) | (30) | (5) | | (28.2) | | | |
| 19 | X | 20-30 | 20-30 | 1-10 | X | 25-30 | X | 5-15 | X |
| | | (22.5) | (27) | (4.5) | | (25.4) | | (10) | |
| 20 | 5-15 | 20-30 | 25-35 | 1-10 | X | 25-30 | X | 5-15 | X |
| | (9) | (22.5) | (27) | (4.5) | | (25.4) | | (10) | |
| 21 | X | 20-30 | 25-35 | 10-20 | X | 25-30 | X | X | X |
| | | (25) | (30) | (15) | | (28.2) | | | |
| 22 | 10-20 | 20-30 | 25-35 | X | 1-5 | 25-30 | X | X | X |
| | (14.7) | (25.2) | (29.3) | | (2) | (27) | | | |
| 23* | 10-20 | 20-30 | 25-35 | X | 1-5 | 25-30 | X | X | 1-10 |
| | (14) | (24) | (28) | | (1.9-2) | (25) | | | (4.9-5) |
| 24 | 10-15 | 20-30 | 20-30 | X | 1-5 | 20-30 | X | X | 5-15 |
| | (13.23) | (22.68) | (26.37) | | (1.8) | (24.3) | | | (10) |
| 25 | 10-15 | 20-25 | 20-30 | X | 1-5 | 20-30 | X | 5-15 | X |
| | (13.23) | (22.68) | (26.37) | | (1.8) | (24.3) | | (10) | |
| 26 | 10-15 | 20-25 | 20-30 | X | 1-5 | 20-25 | X | 5-15 | 1-10 |
| | (12.5) | (21.42) | (24.91) | | (1.7) | (22.95) | | (10) | (5) |
| 27 | 10-20 | 20-30 | 25-35 | X | X | 25-30 | X | X | X |
| | (15) | (25.7) | (30) | | | (27.5) | | | |
| 28 | 10-20 | 20-30 | 25-35 | X | X | 25-30 | X | X | 1-5 |
| | (14.7) | (25.19) | (29.4) | | | (26.95) | | | (2) |
| 29 | 10-20 | 20-30 | 25-35 | X | X | 25-30 | X | X | 1-5 |
| | (14.25) | (24.42) | (28.5) | | | (26.13) | | | (2) |
| 30 | 10-20 | 20-30 | 25-35 | X | X | 20-30 | X | 1-10 | 1-10 |
| | (13.5) | (23.13) | (27) | | | (24.75) | | (5) | (5) |
| 31 | 15-25 | 30-40 | 35-45 | X | X | X | X | X | X |
| | (20.89) | (34.82) | (41.78) | | | | | | |

*MA included at a concentration ranging from 0.5-2% by weight.

Each of the tested formulations was casted in a silicone mold and cured in a UV oven, equipped with 84 LED source (wavelength=380 nm; intensity 80-100 W), for 10 minutes.

Table 3 below presents Elongation at break, Tensile Strength and Resilience (EDE) values measured for the exemplary tested Formulations shown in Table 2, in accordance with the following index:
Elongation (%): Low (L)=below 150; Medium (M)=150-200; Good (G)=>200
Tensile Strength (MPa): Low (L)=below 2; Medium (M)=2-2.5; Good (G)=>2.5
Resilience (EDE) (%): Low (L)=below 20; Medium (M)=20-70; Good (G)=>70

TABLE 3

| | | Tensile | |
|---|---|---|---|
| No. | Elongation | Strength | Resilience |
| 1 | G | G | M |
| 2 | G | M | M |
| 3 | G | G | M |
| 4 | — | — | — |
| 5 | G | G | L |
| 6 | M | G | L |
| 7 | G | M | M |
| 8 | G | G | M |
| 9 | G | L | G |
| 10 | L | L | G |
| 11 | G | M | M |
| 12 | G | M | M |
| 13 | M | L | G |
| 14 | G | G | M |
| 15 | G | G | L |
| 16 | G | G | L |
| 17 | G | G | L |
| 18 | G | G | M |
| 19 | G | G | M |
| 20 | M | L | G |
| 21 | G | G | L |
| 22 | G | G | M |
| 23 | M | M | M |
| 24 | L | M | G |
| 25 | L | L | M |
| 26 | L | L | G |
| 27 | G | G | M |
| 28 | G | M | G |
| 29 | G | L | M |
| 30 | G | L | G |
| 31 | G | M | L |

The following has been concluded from the data presented in Table 3:
Best performance is obtained in formulations that comprise, as Component E, Component E1 (polybutadiene-based urethane (meth)acrylate, at a concentration higher than 20 or higher than 25% by weight;
The inclusion of Component C instead of Component A typically adversely affects the resilience;
A total concentration of Components A and B should preferably be higher than 60 or higher than 70% by weight, since at lower concentration, the tensile strength is adversely affected;
Addition of Component F1 and/or F2 provides for higher resilience;
Component D and/or MA may be added for tuning the mechanical properties.

### Example 3

### Stability

The mechanical properties of objects printed using formulation 2 (see, Table 2) were tested 72 hours after being printed, under the following conditions:
“Dry”—objects printed in glossy mode (without a support material formulation), and maintained at room temperature in a closed bag;
“Wet”—objects printed in glossy mode (without a support material formulation) SUPPORT and placed in water for 72 hours;
“Matte”—objects printed in Matte mode, hardened support removed using a water jet and final objects were dried for 72 hours at room temperature.

Objects shaped as Dog bones models according to ASTMD412 and Die C tear test models according to ASTMD624 were printed using a system such as shown in FIG. 1A, using a LED radiation source (395 nm wavelength). As a support material formulation, the commercially available formulation marketed as Support 710 by Stratasys was used.

Herein, objects printed in matte mode refer to objects printed using a support material formulation, whereby removal of the hardened support material reveals a hardened mixed layer, comprising a hardened mixture of support material and modeling material formulation, which often has a relatively non-reflective appearance, and hence referred to herein as “matte”.

Objects that lack such a hardened mixture (e.g., wherein support material formulation was not applied thereon) are also described herein as “glossy” in comparison.

Table 4 below presents the measured mechanical properties of the printed objects under each of the above conditions, compared to objects formed of a commercially available elastomeric formulation Agilus30™ formulation.

TABLE 4

| | Agilus30 ™ Clear ref | | Hydrophobic rubber | | |
|---|---|---|---|---|---|
| | Dry | Wet | Dry | Wet | Matte |
| Tensile Strength | 2.4 ± 0.2 | 2.2 ± 0.2 | 3.7 ± 0.2 | 3.34 ± 0.1 | 2.7 ± 0.03 |
| (MPa) | | | | | |
| Elongation at | 340 ± 9 | 351 ± 12 | 401 ± 9 | 405 ± 5 | 368 ± 3 |
| break (%) | | | | | |
| Shore Hardness | 33 ± 0.7 | 32 ± 1 | 36 ± 0.55 | 37.5 ± 2.7 | — |
| (A) | | | | | |
| Tear Resistance | 4.3 ± 0.1 | 3.6 ± 0.3 | 6 ± 0.1 | 5.6 ± 0.2 | 5.9 ± 0.1 |
| (Kg/cm) | | | | | |

As can be seen, objects made of an exemplary formulation according to some of the present embodiments feature improved mechanical properties and further exhibit improved stability and durability, seen by minimal deterioration in mechanical properties upon exposure to wet environment.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

It is the intent of the applicant(s) that all publications, patents and patent applications referred to in this specification are to be incorporated in their entirety by reference into the specification, as if each individual publication, patent or patent application was specifically and individually noted when referenced that it is to be incorporated herein by reference. In addition, citation or identification of any reference in this application shall not be construed as an admission that such reference is available as prior art to the present invention. To the extent that section headings are used, they should not be construed as necessarily limiting. In addition, any priority document(s) of this application is/are hereby incorporated herein by reference in its/their entirety.

1-37. (canceled)

38. A curable formulation that provides, when hardened, an elastomeric material, the formulation comprising:
at least one curable, mono-functional, hydrophobic material featuring Tg lower than 0° C.;
at least one curable, mono-functional, hydrophobic material featuring Tg of from 0 to 100, or from 20 to 100, or from 20 to 80, ° C.; and
at least one curable, multi-functional, hydrophobic elastomeric material,
wherein said hardened elastomeric material features at least one of:
elongation at break of at least 200%;
Tensile strength of at least 2 MPa;
Resilience (EDE) of at least 20%;
Tear resistance of at least 5 Kg/cm; and
Shore A hardness of at least 30, or at least 35.

39. The curable formulation of claim 38, wherein each of said curable materials is a UV-curable material.

40. The curable formulation of claim 38, further comprising a photoinitiator.

41. The curable formulation of claim 40, wherein an amount of said photoinitiator ranges from 1 to 3, or from 1 to 2, % by weight of the total weight of the formulation.

42. The curable formulation of claim 38, wherein each of said curable materials is a (meth)acrylic material.

43. The curable formulation of claim 38, wherein said at least one curable, multi-functional, hydrophobic elastomeric material comprises a polybutadiene moiety and/or a multi-functional urethane (meth)acrylate.

44. The curable formulation of claim 38, wherein a total amount of said at least one curable, multi-functional, hydrophobic elastomeric material is at least 20, or at least 25%, by weight, of the total weight of the formulation.

45. The curable formulation of claim 38, wherein said at least one curable, mono-functional, hydrophobic material featuring Tg of from 0 to 100° C. comprises at least one curable material that comprises an alicyclic moiety.

46. The curable formulation of claim 38, wherein said at least one curable, mono-functional, hydrophobic material featuring Tg of from 0 to 100° C. comprises at least one curable, mono-functional, hydrophobic material featuring a viscosity higher than 10 centipoises at 25° C., and at least one curable, mono-functional, hydrophobic material featuring a viscosity lower than 10 centipoises at 25° C.

47. The curable formulation of claim 46, wherein each of said curable, mono-functional, hydrophobic material featuring a viscosity higher than 10 centipoises at 25° C. and said curable, mono-functional, hydrophobic material featuring a viscosity lower than 10 centipoises at 25° C. comprises an alicyclic moiety.

48. The curable formulation of claim 47, wherein a weight ratio of said at least one curable, mono-functional, hydrophobic material featuring a viscosity higher than 10 centipoises at 25° C., and said at least one curable, mono-functional, hydrophobic material featuring a viscosity lower than 10 centipoises at 25° C., ranges from 2:1 to 1:2.

49. The curable formulation of claim 46, wherein:
an amount of said at least one curable, mono-functional, hydrophobic material featuring a viscosity higher than 10 centipoises at 25° C. ranges from 20 to 30, or from 35 to 30, % by weight of the total weight of the formulation; and/or
an amount of said at least one curable, mono-functional, hydrophobic material featuring a viscosity lower than 10 centipoises at 25° C., ranges from 25 to 35, % by weight of the total weight of the formulation.

50. The curable formulation of claim 38, wherein a total amount of said at least one curable, mono-functional, hydrophobic material featuring Tg of from 0 to 100° C. is at least 45, or at least 50, % by weight of the total weight of the formulation.

51. The curable formulation of claim 38, wherein said at least one curable, mono-functional, hydrophobic material featuring Tg lower than 0° C. comprises a linear aliphatic moiety.

52. The curable formulation of claim 38, wherein a total amount of said at least one curable, mono-functional, hydrophobic material featuring Tg lower than 0° C. is at least 10% by weight of the total weight of the formulation.

53. The curable formulation of claim 38, wherein a weight ratio of a total amount of said at least one curable, multi-functional, hydrophobic elastomeric material and a total amount of said at least one curable, mono-functional, hydrophobic material featuring Tg lower than 0° C. ranges from 1:1 to 2:1; and/or.
a weight ratio of a total amount of said at least one curable, mono-functional, hydrophobic material featuring Tg of from 0 to 100° C. and a total amount of said at least one curable, mono-functional, hydrophobic material featuring Tg lower than 0° C. ranges from 2:1 to 3:1; and/or.
a weight ratio of said at least one curable, multi-functional, hydrophobic elastomeric material and a total amount of said at least one curable, multi-functional hydrophobic material featuring Tg of from 0 to 100° C. ranges from 1:1 to 1:2.

54. The curable formulation of claim 38, further comprising at least one curable, multi-functional, material featuring Tg of from 50 to 150° C.; and/or at least one silicone-containing polymeric material.

55. A method of additive manufacturing a three-dimensional object comprising, in at least a portion thereof, an elastomeric material, the method comprising sequentially forming a plurality of layers in a configured pattern corresponding to the shape of the object, thereby forming the object,
wherein the formation of each of at least a few of said layers comprises providing a modeling material formulation as defined in claim 38, and exposing the modeling material to a curing energy to thereby form a cured modeling material,
thereby manufacturing the three-dimensional object.

56. The method of claim 55, wherein said curing energy comprises UV irradiation, wherein said UV irradiation is from a LED energy source.

57. A three-dimensional object manufactured by the method of claim 55.
